(19) United States
(12) Patent Application Publication
(10) Pub. No.: US 2025/0353412 A1
(43) Pub. Date: Nov. 20, 2025

(54) SEAT ANGLE ADJUSTMENT MECHANISM, SUPPORT PLATE, AND CHILD SAFETY SEAT

(71) Applicant: WONDERLAND SWITZERLAND AG, Steihausen (CH)

(72) Inventors: Daliang ZHANG, Dongguan, Guangdong (CN); Ganqing FANG, Dongguan, Guangdong (CN)

(73) Assignee: WONDERLAND SWITZERLAND AG, Steihausen (CH)

(21) Appl. No.: 18/872,347

(22) PCT Filed: Jun. 9, 2023
(86) PCT No.: PCT/EP2023/065440

§ 371 Date: Dec. 6, 2024

(30) Foreign Application Priority Data
Jun. 13, 2022 (CN) 202210660686.1
Jan. 16, 2023 (CN) 202310084177.3

(51) Int. Cl. B60N 2/28

(52) U.S. Cl. CPC B60N 2/2875; B60N 2/2821

(57) ABSTRACT

The present disclosure provides a seat angle adjustment mechanism, a support plate and a child safety seat. The seat angle adjustment mechanism is provided adjusting an angle of the seat part with respect to the base. The seat angle adjustment mechanism includes an unlocking operating member, a connecting member and an angle locking structure. The unlocking operating member is operated to move between an unlocking position and a locking position. The angle locking structure is provided to lock or unlock the seat part with respect to the base. When the unlocking operating member is in the locking position, the seat part is positioned with respect to the base. When the unlocking operating member is in the unlocking position, the seat part is slidable with respect to the base.

### TECHNICAL FIELD

The present disclosure relates to the field of child products, in particular to a child safety seat, and more specifically to a seat angle adjustment mechanism and a child safety seat having the seat angle adjustment mechanism.

### BACKGROUND

In recent years, with increasing attention on children's travel safety, more and more people choose to use the child safety seats. Generally, a front end of the child safety seat may be provided with a support plate to prevent the child safety seat from being overturned by abutting against a backrest of a vehicle seat when the child safety seat is used in a rear-facing mode.

In addition, some of the child safety seats may also be provided with a seat angle adjustment mechanism to provide different seat angles for children seated in the child safety seats.

### SUMMARY

An object of the present disclosure is to provide a child safety seat capable of adjusting a support plate and an angle of a seat.

The present disclosure provides a seat angle adjustment mechanism. The seat angle adjustment mechanism is provided between the seat part and the base of the child safety seat for adjusting an angle of the seat part with respect to the base. The seat angle adjustment mechanism includes an unlocking operating member, a connecting member and an angle locking structure. The unlocking operating member is provided on a support plate connected to a front end of the seat part and may be operated to move between an unlocking position and a locking position. The angle locking structure is provided between the seat part and the base to lock or unlock a position of the seat part with respect to the base. The angle locking structure has a plurality of locking positions with respect to the base to lock the seat part at a plurality of angles with respect to the base. The connecting member is connected between the unlocking operating member and the angle locking structure. When the unlocking operating member is in the locking position, the seat part is positioned with respect to the base. When the unlocking operating member is operated to the unlocking position, the seat part is slidable with respect to the base.

In one embodiment, the unlocking operating member is slidably provided on the support plate, and is at least partially exposed from the support plate.

In one embodiment, the unlocking operating member is provided on a lower side of a front end of the support plate, and is at least partially exposed from the lower side of the support plate.

In one embodiment, the seat angle adjustment mechanism further includes a reset member. The reset member is provided between the unlocking operating member and the support plate, and configured to bias the unlocking operating member towards the locking position.

In one embodiment, the angle locking structure includes an engaging pin. The engaging pin is movably provided on the seat part, one end of the engaging pin is linked with the unlocking operating member through the connecting member, so that the engaging pin may be engaged with at least one engaging hole provided on the base with variations of angles of the seat part relative to the base.

In one embodiment, the angle locking structure further includes an engaging reset member. The engaging reset member is provided between the seat part and the engaging pin to bias the engaging pin towards a corresponding one of the engaging holes.

In one embodiment, the connecting member is a flexible element.

The present disclosure also provides a child safety seat. The child safety seat includes a seat part, a base and a support plate. The support plate is provided on the seat part, and the base is configured to seat the seat part. The seat angle adjustment mechanism according to any one of the foregoing embodiments is provided between the seat part and the base.

In one embodiment, the seat part is slidably connected to the base through at least one sliding assembly. The sliding assembly or each of the at least one sliding assembly includes a sliding member and a sliding-fit member. The sliding member is provided on the seat part. The sliding-fit member is provided on the base, and slidingly fit to the sliding member.

In one embodiment, the sliding member is a screw fixed to a bottom of the seat part through a connecting column, and the sliding-fit member is an arc-shaped elongated slot extending along a direction in which the seat part slides with respect to the base on an upper surface of the base.

In one embodiment, the sliding member is an arc-shaped sliding slot provided on a bottom side surface of the seat part, and the sliding-fit member is an inserting pin correspondingly provided on the base.

In one embodiment, the support plate is slidable with respect to the seat part such that the support plate is telescopic from the front end of the seat part.

In one embodiment, the support plate is provided with a support plate adjustment mechanism for adjusting a length of the support plate extending from the seat part.

In one embodiment, the support plate includes a body and a connecting element. The body is formed by connecting an upper cover, a lower cover, and a bottom plate, the upper cover and the lower cover form a part of the support plate exposed to the seat part, and the bottom plate is connected to a rear end of the upper cover and a rear end of the lower cover and located between the upper cover and the lower cover.

In one embodiment, the bottom plate has an extension provided with a receiving slot for fixing the connecting member of the seat angle adjustment mechanism.

In one embodiment, the support plate further includes a connecting element, at least a portion of the connecting element is fixed on the body, another portion of the connecting element extends from the body, and a length of the extension is less than a length of the connecting element extending from the body.

In one embodiment, the support plate includes a body and a connecting element. At least a portion of the connecting element is fixed on the body, and another portion of the connecting element extends from the body to be inserted into a connecting hole which is correspondingly provided on the seat and is complementary in shape, so that the support plate is slidably connected to seat part.

In one embodiment, the support plate is provided with a first sliding element slidingly fit to a second sliding element correspondingly provided on the seat part, so that the support plate is slidably connected to the seat part.

In one embodiment, one of the first sliding element and the second sliding element is a sliding rib, and the other one of the first sliding element and the second sliding element is a sliding slot.

In one embodiment, the support plate adjustment mechanism includes an operating element and a positioning structure. The operating member is slidably provided on the support plate, may slide between a locking position and a releasing position, and is at least partially exposed from the support plate. The positioning structure is provided on the support plate and linked with the operating element to position the support plate in at least one position of the seat part. When the operating element is in the locking position, the positioning structure is locked so that the support plate is positioned with respect to the seat part. When the operating element is operated to the releasing position, the positioning structure is unlocked, so that the support plate is movable with respect to the seat part.

In one embodiment, the support plate adjustment mechanism further includes an elastic element provided between the operating element and the support plate to bias the operating element towards the locking position.

In one embodiment, the positioning structure includes a first locking element. The first locking element is provided on the support plate. As the operating element moves between the locking position and the releasing position, the first locking element may be engaged with the second locking element correspondingly provided on the seat part or disengaged from the second locking element.

In one embodiment, the first locking element is fixedly provided on a fixing seat at an end of the support plate, and the operating element is provided with an inclined slot slidingly fit to the fixing seat through a linkage pin provided on the fixing seat. In an example, when the operating element is operated to move from the locking position to the releasing position, the operating element moves the fixing seat through the inclined slot, such that the first locking element is driven to disengage from the seat part.

In one embodiment, the support plate is provided with a first limiting piece, and the seat part is correspondingly provided with a second limiting piece, and the first limiting piece and the second limiting piece are cooperated to limit a stroke of the support plate extending with respect to the seat.

In one embodiment, the support plate adjustment mechanism includes a first locking element. The first locking element is provided on a body of the support plate and may move between a locking position and an unlocking position. When the first locking element is in the locking position, the first locking element may be engaged with a second locking element on the seat part to position the support plate with respect to the seat part. When the first locking element is in the unlocking position, the first locking element is disengaged from the second locking element on the seat part so that the support plate is slidable with respect to the seat part.

In one embodiment, the first locking element is provided on a lower surface of the body, and when the first locking element is in the locking position, an engaging end of the first locking element passes through a through hole on the body and protrudes from an upper surface of the body.

In one embodiment, the first locking element is a strip pivotally connected to the lower surface of the body, the strip is pivotable so that the engaging end protrudes from the upper surface of the body as it is in the locking position, and the engaging end retracts into the body as it is in the unlocking position.

In one embodiment, the second locking element is provided as a positioning hole provided on the lower surface of the seat part.

In one embodiment, a plurality of positioning holes are provided along a front-rear direction of the seat part.

In one embodiment, the support plate further includes an operating element provided on the body. The operating element may be operated to drive the first locking element to move between the locking position and the unlocking position.

In one embodiment, the support plate further includes an elastic element configured to bias the first locking element towards the locking position.

In one embodiment, the elastic element is a torsion spring, a compression spring, a tension spring, a hydraulic rod or a pneumatic rod.

In one embodiment, the support plate further includes an elastic element configured to bias the first locking element towards the locking position. The operating element is provided as a handle capable of sliding on the lower surface of the body, the handle is provided with a pushing rib, and the pushing rib is capable of pushing the first locking element to resist an elastic force of the elastic element and then move the first locking element from the locking position to the unlocking position.

In one embodiment, the body is provided with a limiting rib, the seat part includes a cover at a front side, the cover is provided with a limiting slot, and a vertical segment of the limiting rib may be blocked by a blocking part of the limiting slot to prevent the support plate from being separated from the seat part.

The present disclosure also provides a support plate for a child safety seat. The support plate is slidably connected to a seat part of the child safety seat and can slide and be positioned between an extended position and a retracted position. The support plate includes: a body; a first sliding element provided on the body and configured to slidingly fit to a second sliding element of the seat part; and a first locking element provided on the body, and capable of moving between a locking position and an unlocking position, wherein the first locking element engages with a second locking element on the seat part when the first locking element is in the locking position, so that the support plate is positioned with respect to the seat part, and the first locking element disengages from the second locking element on the seat part when the first locking element is in the unlocking position, so that the support plate is capable of sliding with respect to the seat part.

In one embodiment, the support plate further includes a connecting element fixedly connected to the body, and a connecting hole into which the connecting element is inserted is formed on the seat part.

In one embodiment, the body is formed by connecting an upper cover, a lower cover and a bottom plate, the upper cover and the lower cover form a part of the support plate exposed to the seat part, and the bottom plate is connected to a rear end of the upper cover and a rear end of the lower cover and located between the upper cover and the lower cover.

In one embodiment, the bottom plate has an extension provided with a receiving slot for fixing the connecting member of the seat angle adjustment mechanism.

In one embodiment, the support plate further includes a connecting element, at least a portion of the connecting element is fixed on the body, another portion of the connecting element extends from the body, and a length of the extension is less than a length of the connecting element extending from the body.

In one embodiment, the first sliding element is one of a sliding rib and a sliding slot provided on an upper surface of the body, and the second sliding element is the other one of the sliding rib and the sliding slot provided on a lower surface of the body.

In one embodiment, the first locking element is provided on a lower surface of the body, and when the first locking element is in the locking position, an engaging end of the first locking element passes through a through hole on the body and protrudes from an upper surface of the body.

In one embodiment, the first locking element is a strip pivotally connected to the lower surface of the body, the strip is pivotable so that the engaging end protrudes from the upper surface of the body as it is in the locking position, and the engaging end retracts into the body as it is in the unlocking position.

In one embodiment, the second locking element is provided as a positioning hole provided on the lower surface of the seat part.

In one embodiment, a plurality of positioning holes are provided along a front-rear direction of the seat part.

In one embodiment, the support plate further includes an operating element provided on the body. The operating element may be operated to drive the first locking element to move between the locking position and the unlocking position.

In one embodiment, the support plate further includes an elastic element configured to bias the first locking element towards the locking position.

In one embodiment, the elastic element is a torsion spring, a compression spring, a tension spring, a hydraulic rod or a pneumatic rod.

In one embodiment, the support plate further includes an elastic element configured to bias the first locking element towards the locking position. The operating element is provided as a handle capable of sliding on the lower surface of the body, the handle is provided with a pushing rib, and the pushing rib is capable of pushing the first locking element to resist an elastic force of the elastic element and then move the first locking element from the locking position to the unlocking position.

In one embodiment, the body is provided with a limiting rib, the seat part includes a cover at a front side, the cover is provided with a limiting slot, and a vertical segment of the limiting rib may be blocked by a blocking part of the limiting slot to prevent the support plate from being separated from the seat part.

In one embodiment, the first locking element is fixedly provided on a fixing seat at an end of the support plate, and the operating element is provided with an inclined slot slidingly fit to the fixing seat through a linkage pin provided on the fixing seat. When the operating element is operated to move from the locking position to the releasing position, the operating element moves the fixing seat through the inclined slot, so that the first locking element is driven to disengage from the seat part.

In one embodiment, the support plate is provided with a first limiting piece, and the seat part is correspondingly provided with a second limiting piece, and the first limiting piece and the second limiting piece are cooperated to limit a stroke of the support plate extending with respect to the seat.

In another aspect, the present disclosure provides a child safety seat provided with a support plate according to the present disclosure.

The foregoing and other objects, features, aspects and advantages of the present disclosure will become more apparent from the following detailed description of the present disclosure in conjunction with the accompanying drawings.

### BRIEF DESCRIPTION OF THE DRAWINGS

The accompanying drawings, which are included to provide a further understanding of the present disclosure and are incorporated in and constitute a part of this specification, illustrate embodiments of the present disclosure and together with the description as described below serve to explain the concept of the present disclosure.

FIG. 1 is a side view of a child safety seat provided with a support plate according to an embodiment of the present disclosure, in which the support plate is in a retracted position.

FIG. 2A is a side view of the child safety seat provided with the support plate according to an embodiment of the present disclosure, in which the support plate is in an extended position.

FIG. 2B is a cross-sectional view taken along a line “A-A” in FIG. 2A and a partial enlarged view of the child safety seat.

FIG. 3 is a perspective view and a partial enlarged view of the child safety seat in FIG. 2A when viewed from below after the support plate is removed.

FIG. 4 is a perspective view and a partial enlarged view of one example of the support plate according to an embodiment of the present disclosure.

FIG. 5 is a partial enlarged perspective view of the child safety seat in FIG. 2A when viewed from below.

FIG. 6 is a partial enlarged view of one example of the support plate according to an embodiment of the present disclosure when viewed from below.

FIG. 7A is a bottom view of the child safety seat in FIG. 2A.

FIG. 7B is a cross-sectional view taken along a line “B-B” in FIG. 7A and a partial enlarged view of the child safety seat.

FIG. 8A is a perspective view of the child safety seat in FIG. 2A when viewed from above.

FIG. 8B is a side partial cross-sectional view taken along a line “C-C” in FIG. 8A and a partial enlarged view of the child safety seat.

FIG. 9 is a side cross-sectional view and a partial enlarged view of the child safety seat in FIG. 2A.

FIG. 10 shows a perspective view of the child safety seat according to another embodiment of the present disclosure.

FIG. 11 shows a perspective view of another state of the child safety seat shown in FIG. 10.

FIG. 12 shows a side cross-sectional view of the child safety seat shown in FIG. 11.

FIG. 13 shows a perspective view of the child safety seat viewed from another angle according to another embodiment of the present disclosure.

FIG. 14 shows a perspective view of the child safety seat viewed from yet another angle according to another embodiment of the present disclosure.

FIG. 15 shows a perspective view of the support plate according to another embodiment of the present disclosure.

FIG. 16 shows a partial perspective view of the child safety seat according to another embodiment of the present disclosure.

FIG. 17 shows a perspective view of the child safety seat according to another embodiment of the present disclosure, in which a bottom cover plate between the support plate and a seat part is removed.

FIG. 18 shows a partial perspective view of the child safety seat according to another embodiment of the present disclosure, in which an upper cover of the support plate is removed.

FIG. 19 shows a partial perspective view of the child safety seat shown in FIG. 17 in another state.

FIG. 20 shows a perspective view of a base according to another embodiment of the present disclosure.

FIG. 21 shows another partial perspective view of the child safety seat according to another embodiment of the present disclosure, in which the upper cover of the support plate is removed.

FIG. 22 shows a top partial perspective view of the support plate and the seat part according to another embodiment of the present disclosure.

FIG. 23 shows a cross-sectional view taken along a line “D-D” in FIG. 22.

FIG. 24 shows a perspective view of the support plate according to another embodiment of the present disclosure, in which the upper cover and a bottom plate are removed.

FIG. 25 shows another side cross-sectional view of the child safety seat according to another embodiment of the present disclosure.

List of Reference Numbers:

| | |
|---|---|
| 100 | Support Plate |
| 110 | Body |
| 110A | Upper Surface |
| 110B | Lower Surface |
| 110C | Through Hole |
| 111 | Limiting Rib |
| 111A | Vertical Segment |
| 120 | First Sliding Element |
| 130 | First Locking Element |
| 131 | Engaging End |
| 140 | Operating Element |
| 141 | Pushing Rib |
| 150 | Reinforcing Tube |
| 160 | Elastic Element |
| 200 | Seat Part |
| 210 | Cover |
| 211 | Limiting Slot |
| 211A | Blocking Part |
| 220 | Second Sliding Element |
| 230 | Second Locking Element |
| 250 | Connecting Hole |
| 300 | Support Plate |
| 310 | Body |
| 311 | Upper Cover |
| 312 | Lower Cover |
| 312A | Window |
| 313 | Bottom Plate |
| 313a | Extension |
| 3131 | Receiving Slot |
| 320 | Connecting Element |
| 330 | First Sliding Element |
| 340 | Support Plate Adjustment Mechanism |
| 341 | Operating Element |
| 342 | Elastic Element |
| 343 | Positioning Structure |
| 3431 | First Locking Element |
| 3432 | Fixing Seat |
| 3433 | Return Spring |
| 3434 | Linkage Pin |
| 3435 | Inclined Slot |
| 350 | First Limiting Piece |
| 400 | Seat Part |
| 401 | Connecting Hole |
| 402 | Second Sliding Element |
| 410A | Sliding Member |
| 410B | Sliding Member |
| 410C | Connecting Column |
| 421 | Unlocking Operating Member |
| 422 | Connecting Member |
| 423 | Reset Member |
| 424 | Angle Locking Structure |
| 4241 | Engaging Pin |
| 4242 | Engaging Reset Member |
| 430 | Positioning Slot |
| 440 | Second Limiting Piece |
| 500 | Base |
| 510 | Engaging Hole |
| 520A | Sliding-fit Member |
| 520B | Sliding-fit Member |

### DETAILED DESCRIPTION

Hereinafter, exemplary embodiments of the present disclosure will be described in detail with reference to the accompanying drawings. While the present disclosure may be modified or substituted in various forms, specific embodiments thereof are shown by way of examples in the accompanying drawings. However, the present disclosure should not be construed as limiting the embodiments as set forth herein, on the contrary, the present disclosure is intended to cover all modifications, equivalents, and alternatives within the spirit and scope of the present disclosure.

Hereinafter, the present disclosure will be described in detail with reference to the accompanying drawings.

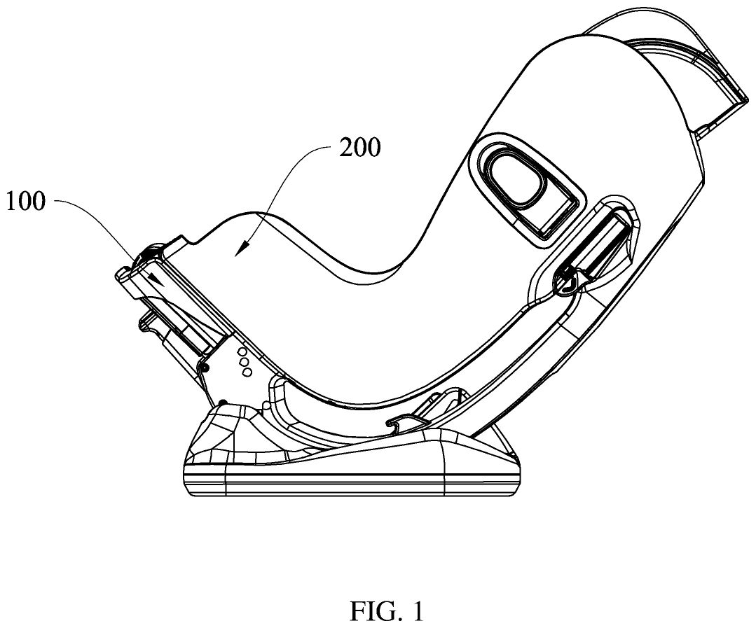

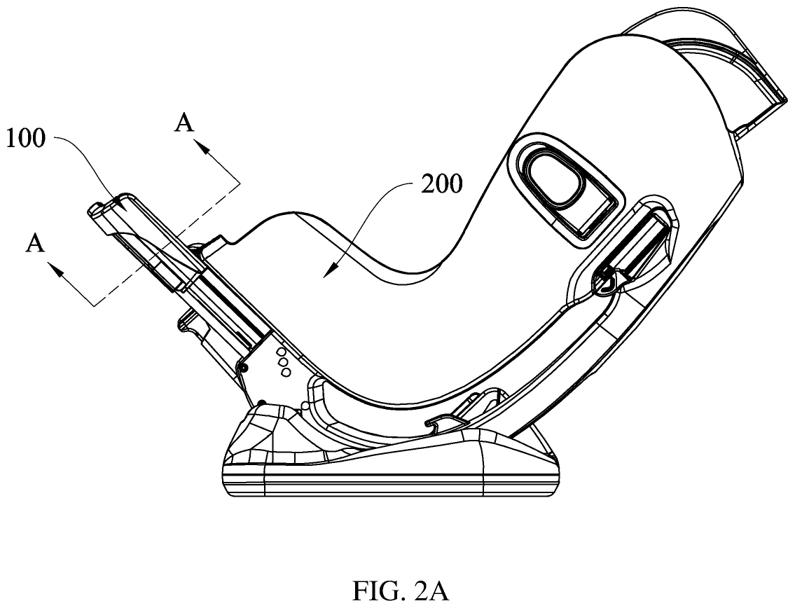

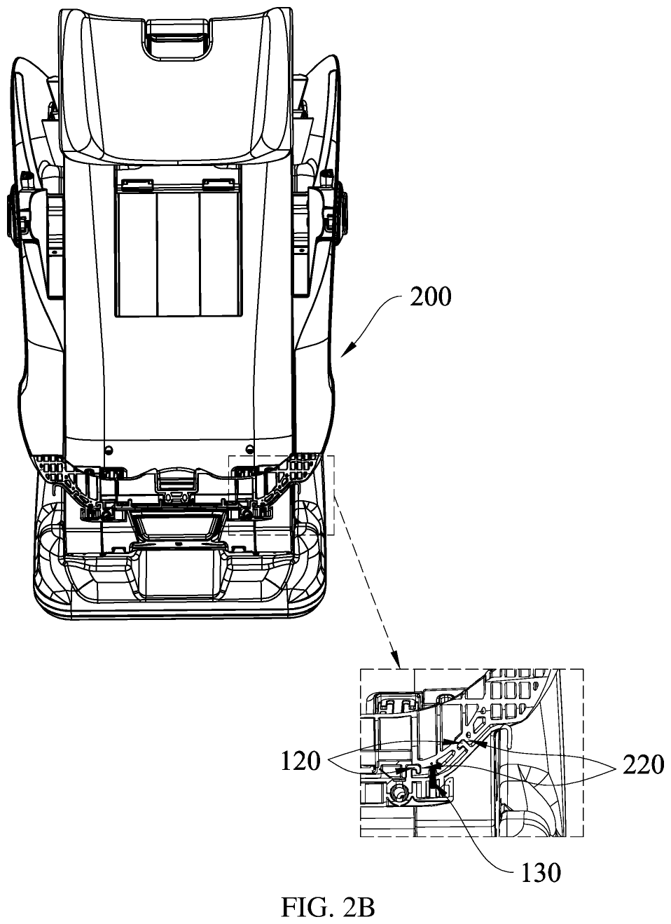

In one embodiment of the present disclosure, a child safety seat is provided. Specifically, FIGS. 1, 2A and 2B show a child safety seat provided with a support plate 100 according to the present disclosure. The support plate 100 may be slidably connected to a seat part 200 of the child safety seat, for example, connected to a lower front side of the seat part 200, and may be slidable forward and rearward and be positioned between a retracted position shown in FIG. 1 and an extended position shown in FIG. 2A. Herein, a direction towards which the child safety seat faces may be defined as “front”, and a direction from which the child safety seat faces away may be defined as “rear”. The support plate 100 may slide forward and rearward along the seat part 200 and be positioned at different positions, such that the support plate 100 according to the present disclosure can be used in conjunction with different vehicle models, and can provide a large space for legs of a child sitting on the child safety seat so as to provide more safety and comfort experience.

Specifically, the support plate 100 according to the present disclosure includes a body 110 and a first sliding element 120 disposed on the body 110. The body 110 may be, for example, in a plate shape, or in other shapes such as a block shape. The first sliding element 120 may be slidingly fit to a second sliding element 220 disposed on the seat part 200, so that the support plate 100 may slide forward and rearward along the seat part 200.

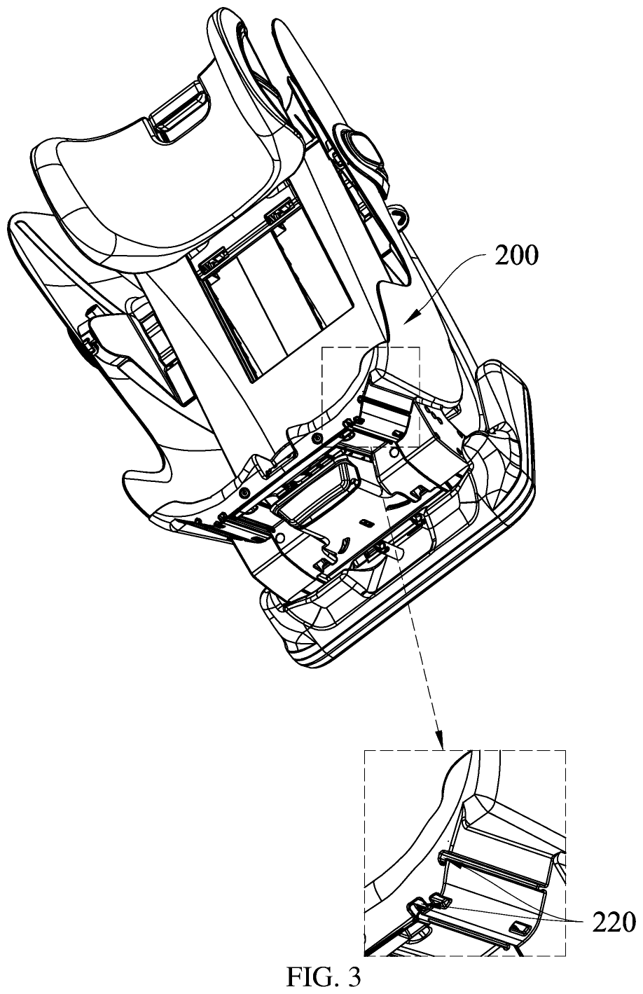

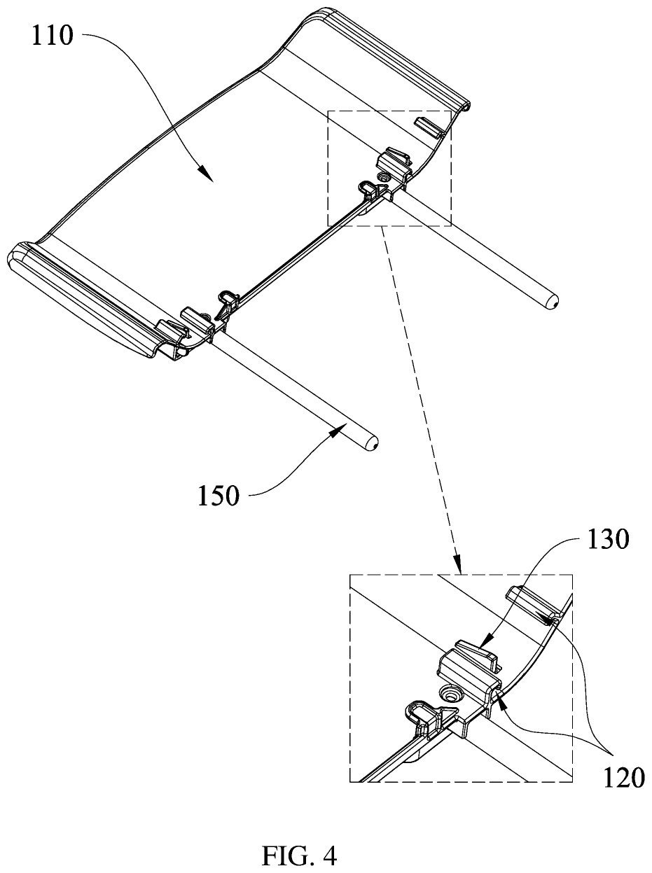

In an embodiment shown in FIGS. 2B, 3 and 4, the first sliding element 120 may be a sliding rib located on an upper surface 110A of the body 110 (see FIG. 4), and the second sliding element 220 may be a sliding slot located on a lower surface of the seat part 200 (see FIG. 3). The sliding rib on the body 110 of the support plate 100 may be inserted into the sliding slot on the seat part 200 and slidable in the sliding slot, so that the support plate 100 may slide forward and rearward along the seat part 200.

In addition, the first sliding part 120 may also be a sliding slot on the upper surface 110A of the body 110, and the second sliding part 220 may also be a sliding rib on the lower surface of the seat part 200.

Of course, the present disclosure may not be limited thereto. The first sliding element 120 disposed on the body 110 and the second sliding element 220 disposed on the seat part 200 may also use other sliding-fit structures, as long as the support plate 100 can slide with respect to the seat part 200. For example, the first sliding element 120 may be a sliding rod disposed on the body 110, and the second sliding element 220 may be a sliding ring disposed on the seat part 200.

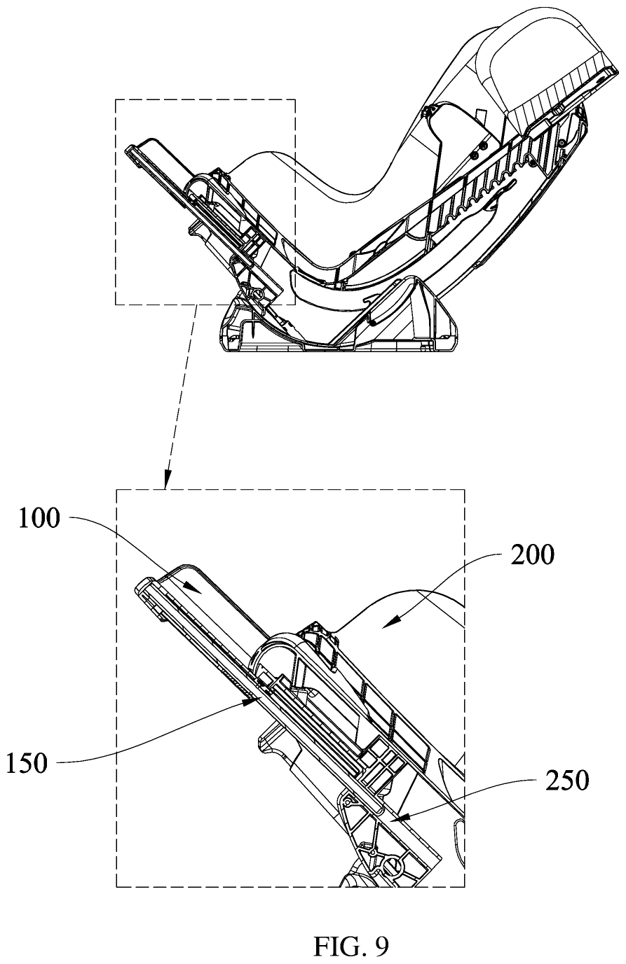

In one embodiment, as shown in FIGS. 4 and 9, the support plate 100 according to the present disclosure may further include a connecting element fixedly connected to the body 110. In this embodiment, as an example of a reinforcing tube 150, a connecting hole 250 into which the reinforcing tube 150 is inserted may be formed on the seat part 200. After the support plate 100 is assembled to the seat part 200, the reinforcing tube 150 may be inserted into the connecting hole 250, and as the support plate 100 is slidable and adjustable with respect to the seat part 200, the reinforcing tube 150 may be slidable in the connecting hole 250, so that the support plate 100 may be guided to slide along the seat part 200 forward and rearward, and when the support plate 100 protrudes out of a front side of the seat part 200, especially when a part of the support plate 100 protruding from the front side of the seat part 200 is larger than a part hidden in the lower surface of the seat part 200, the reinforcing tube 150 inserted into the connecting hole 250 can greatly enhance the supporting capacity of the support plate 100.

In the embodiment shown in FIG. 4, two reinforcing tubes 150 fixedly connected to the body 110 of the support plate 100 may be provided and are respectively located on left and right sides of the body 110 of the support plate 100, to evenly share a stress applied by the support plate 100. The number and shape of the reinforcing tubes 150 may vary as desired. For example, there may be one, three or more reinforcing tubes 150, and the reinforcing tubes 150 may be not only in a shape of a circular tube, but also in other shapes such as a square tube. Correspondingly, the connecting hole 250 into which the reinforcing tube 150 is inserted may also have a number and shape corresponding to that of the reinforcing tubes. Materials of the reinforcing tube 150 may be different from that of the support plate 100 and the seat part 200, such as a metal having strong rigidity, preferably stainless steel, carbon steel, and the like.

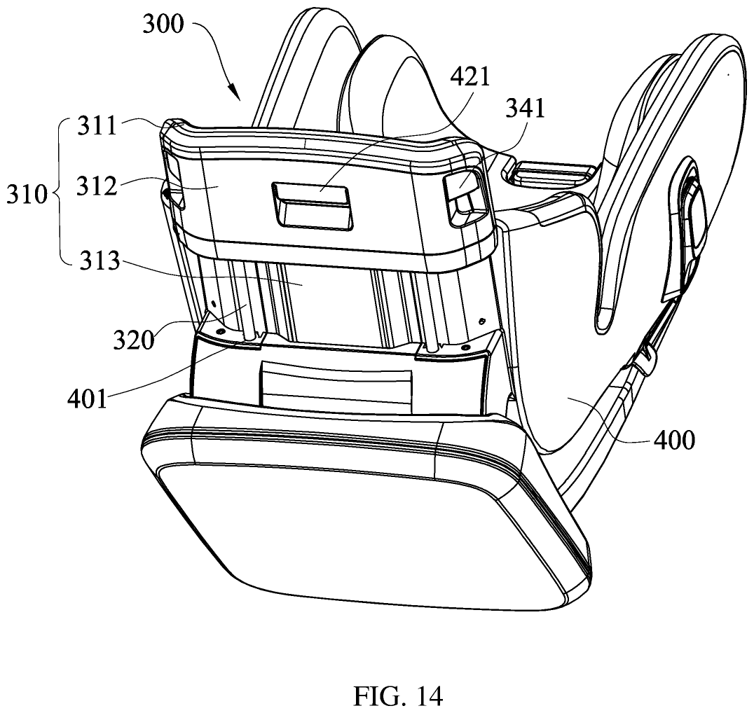

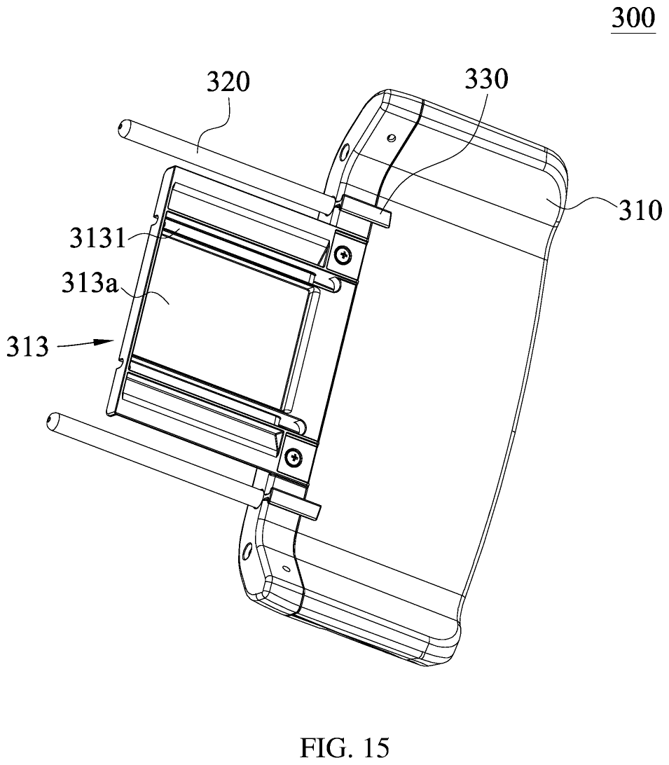

It should be noted that the support plate 100 may also be slidably connected to the seat part 200 only through the connecting element (such as “the reinforcing tube 150” in the above-mentioned embodiment), that is, without the cooperation between the first sliding element and the second sliding element. Regarding this embodiment, reference may also be made to the description in conjunction with FIGS. 14 and 15 below.

When the support plate 100 may be slidable between the extended position and the retracted position, the support plate 100 according to the present disclosure may further include a first locking element 130, in order to adjust and position the support plate 100 at different positions with respect to the seat part 200, such that the support plate may be used in different vehicle models. The first locking element 130 is disposed on the body 110 and may be movable between a locking position and an unlocking position. When the first locking element 130 is in the locking position, it may engage with a second locking element 230 on the seat part 200 such that the support plate 100 may be positioned with respect to the seat part 200. When the first locking element 130 is in the unlocking position, it disengages from the second locking element 230 on the seat part 200 such that the support plate 100 may be slidable with respect to the seat part 200 and may be adjusted to a proper position.

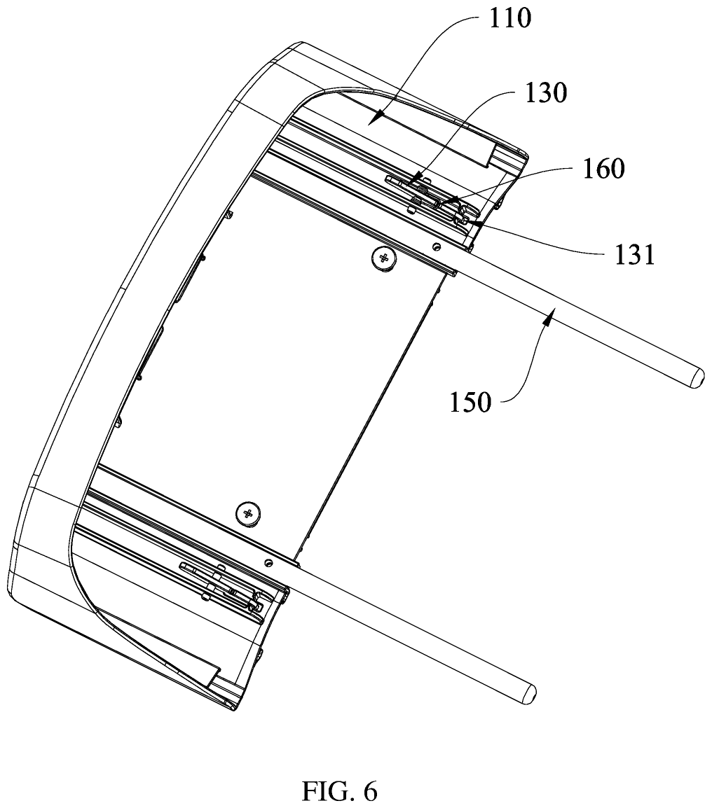

The first locking element 130 may be disposed on the lower surface 110B of the body 110, and when it is in the locking position, an engaging end 131 of the first locking element 130 may pass through a through hole on the body 110 and protrude from the upper surface 110A of the body 110, to engage with the second locking element 230 on the seat part 200. For example, in the embodiment shown in FIGS. 4, 6 and 7B, the first locking element 130 is a strip pivotally connected to the lower surface 110B of the body 110 (see FIG. 6). The strip may be pivotable so that when it is in the locking position, the engagement end 131 thereon may pass through the body 110 and protrude from the upper surface 110A of the body 110 (see FIG. 4).

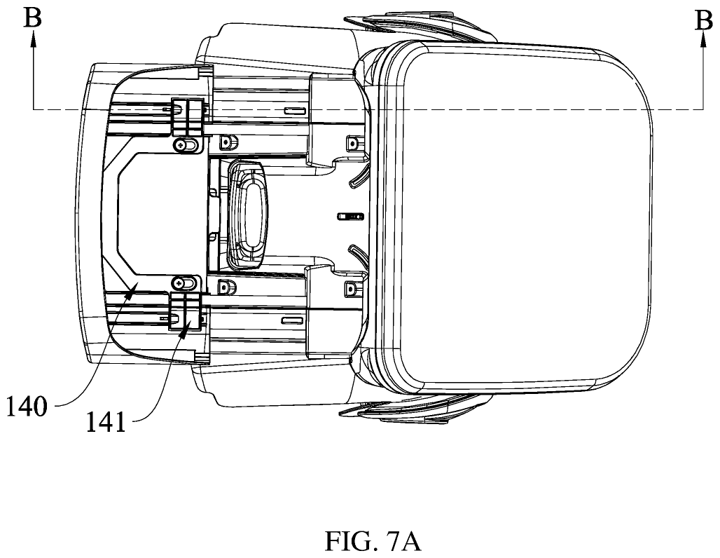

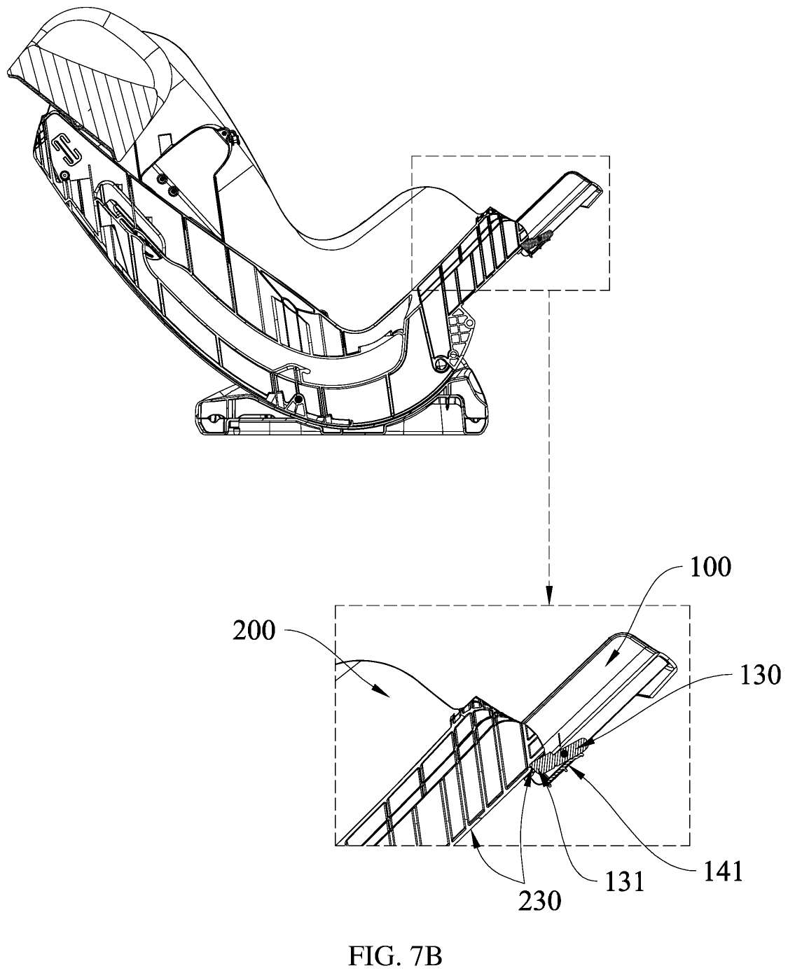

In the embodiment shown in FIG. 7B, the second locking element 230 is a positioning hole disposed on the lower surface of the seat part 200.

When the strip served as the first locking element 130 is in the locking position, the engaging end 131 may pass through the body 110 and protrude from the upper surface 110A of the body 110 to engage with the positioning hole served as the second locking element 230 on the seat part 200, so that the support plate 100 may be positioned in this position with respect to the seat part 200. When the strip served as the first locking element 130 is in the unlocking position, the engaging end 131 may retract into the body 110 and disengage from the positioning hole served as the second locking element 230 on the seat part 200, and at this moment, the support plate 100 may be freely slidable with respect to the seat part 200.

It should be understood that a plurality of positioning holes served as the second locking element 230 may be provided in a front and rear direction of the seat part 200. The engaging end 131 of the strip served as the first locking element 130 are engaged with different positioning holes, the support plate 100 may be positioned at different positions with respect to the seat part 200 so that it can be used in different vehicle models.

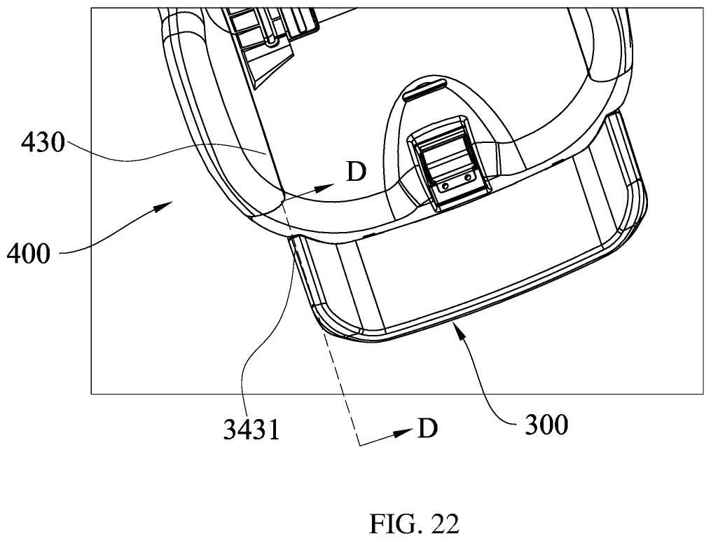

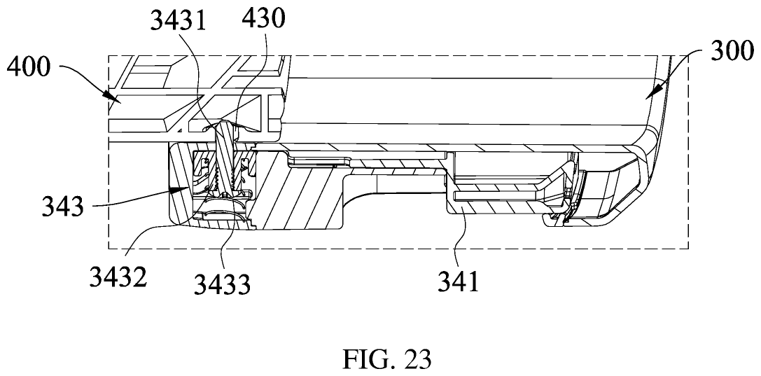

Of course, the present disclosure may not be limited thereto. According to the present disclosure, the first locking element 130 of the support plate 100 and the second locking element 230 on the seat part 200 may adopt other cooperating structures, as long as these cooperating structures can realize the locking and unlocking of the support plate 100 with respect to the seat part 200. For example, the first locking element 130 may be a positioning hole disposed on the body 110 of the support plate 100, and the second locking element 230 may be a strip disposed on the seat part 200. Alternatively, the first locking element 130 may be a positioning pin disposed to the body 110 of the support plate 100, and the second locking element 230 may be a positioning slot disposed on the seat part 200. In addition, the “positioning structure” (corresponding to the first locking element 130 in this embodiment) configured to position the seat part to the base may also refer to an assembly including a plurality of elements or parts or components, rather than a single component, reference can be made to the positioning structure 343 shown in the subsequent embodiments of FIGS. 22 and 23, but the present disclosure may not be limited thereto.

In order to facilitate the user to operate the engagement and disengagement between the first locking element 130 of the support plate 100 and the second locking element 230 on the seat part 200, the support plate 100 according to the present disclosure may further include an operating element 140. The operating element 140 is disposed to the body 110 and may be operated by a user to drive the movement of the first locking element 130 between the locking position and the unlocking position. When the operating element 140 is operated by the user to drive the movement of the first locking element 130 between the locking position and the unlocking position, the first locking element 130 of the support plate 100 disengages from the second locking element 230 on the seat part 200. When the operating element 140 is operated by the user to drive the movement of the first locking element 130 between the unlocking position and the locking position, the first locking element 130 of the support plate 100 engages with the second locking element 230 on the seat part 200.

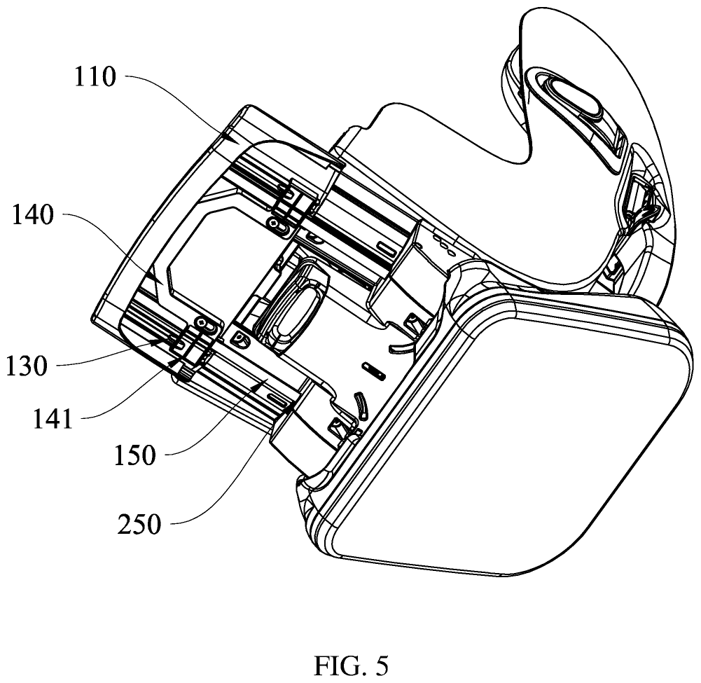

In the embodiment shown in FIG. 5, the operating element 140 is a slidable handle disposed on the lower surface 110B of the body 110. For example, the handle may be provided with a sliding slot in cooperation with the reinforcing tube 150, so that the handle may be slidable along the reinforcing tube 150. A pushing rib 141 is provided on the handle. As it is required to adjust the support plate 100, the user pulls the handle served as the operating part 140, and the pushing rib 141 on the handle may push the first locking element 130 to move from the locking position to the unlocking position, so that the first locking element of the support plate 100 130 disengages from the second locking element 230 on the seat part 200, and the support plate 100 may be adjusted with respect to the seat part 200.

Of course, the operating element 140 according to the present disclosure may also employ other structures, as long as it can drive the movement of the first locking element 130. For example, the operating element 140 may be a button or an operating rod, and the user drives the movement of the first locking element 130 between the locking position and the unlocking position by pressing the button or pulling the operating rod.

In order to operate the operating element 140 easily, in the embodiment shown in FIG. 6, the support plate 100 may further include an elastic element 160 disposed to bias the first locking element 130 towards the locking position. In the embodiment shown in FIG. 6, the elastic element 160 may be a torsion spring disposed at a pivot shaft of the strip served as the first locking element 130, and the torsion spring may pivot the strip served as the first locking element 130, so that the engaging end 131 thereof may pass through the body 110 and protrude from the upper surface 110A of the body 110 to engage with the positioning hole served as the second locking element 230 on the seat part 200. The elastic element 160 may be configured such that the user may only need to operate the operating element 140 to resist an elastic force of the elastic element 160 and drive the movement of the first locking element 130 from the locking position to the unlocking position, and the engaging end 131 may retract into the body 110, such that the disengagement between the first locking element 130 of the support plate 100 and the second locking element 230 on the seat part 200 can be implemented. Once the user no longer applies a force on the operating element 140, the elastic element 160 will bias the first locking element 130 to move from the unlocking position to the locking position. In this way, it is convenient for the operation of the user, and the structure of the operating element 140 can be simplified as it is unnecessary for the operating element to drive the movement of the first locking element 130 from the unlocking position to the locking position.

It should be understood that the elastic element 160 in the present disclosure may also adopt various elastic structures such as a compression spring, a tension spring, a hydraulic rod or a pneumatic rod, as long as the first locking element 130 may be biased towards the locking position.

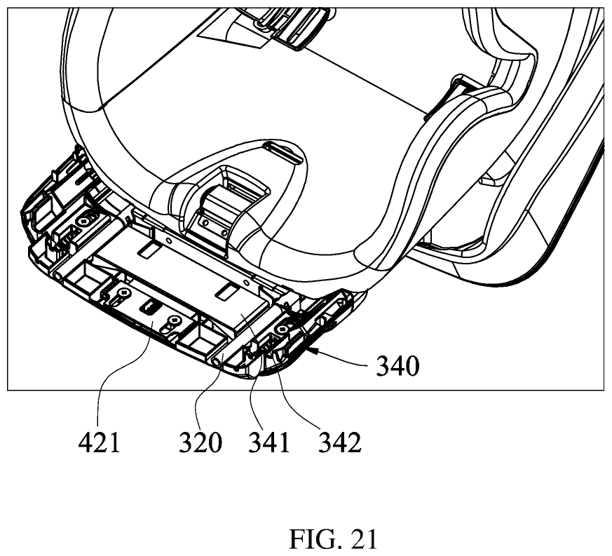

It can be understood that, in the embodiments as described above in combination with FIGS. 4 to 7B, the first locking element 130 included in the support plate 100, optionally, the operating element 140 and the elastic element 160 may be configured as a support plate adjustment mechanism for adjusting and positioning the support plate 100 to different positions with respect to the seat part 200. Of course, the support plate adjustment mechanism may also be arranged in other different structures, for example, another support plate adjustment mechanism may be described below with reference to FIGS. 21 to 24.

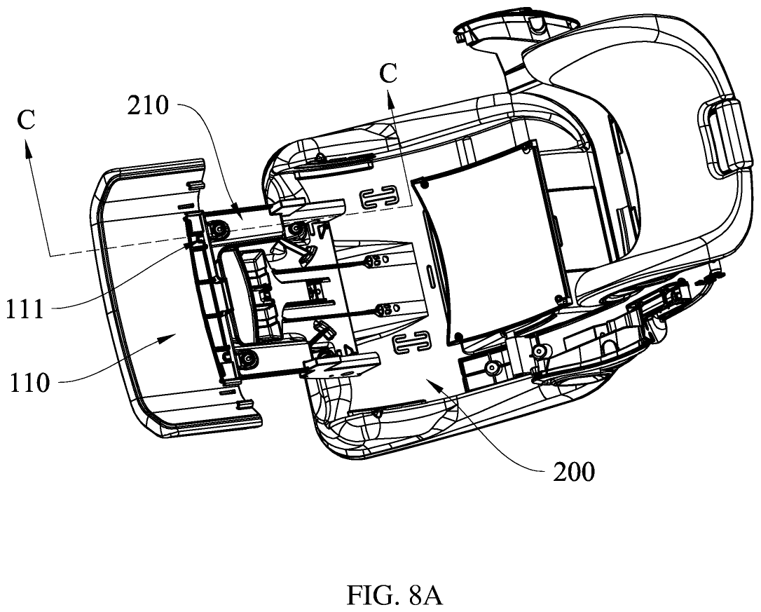

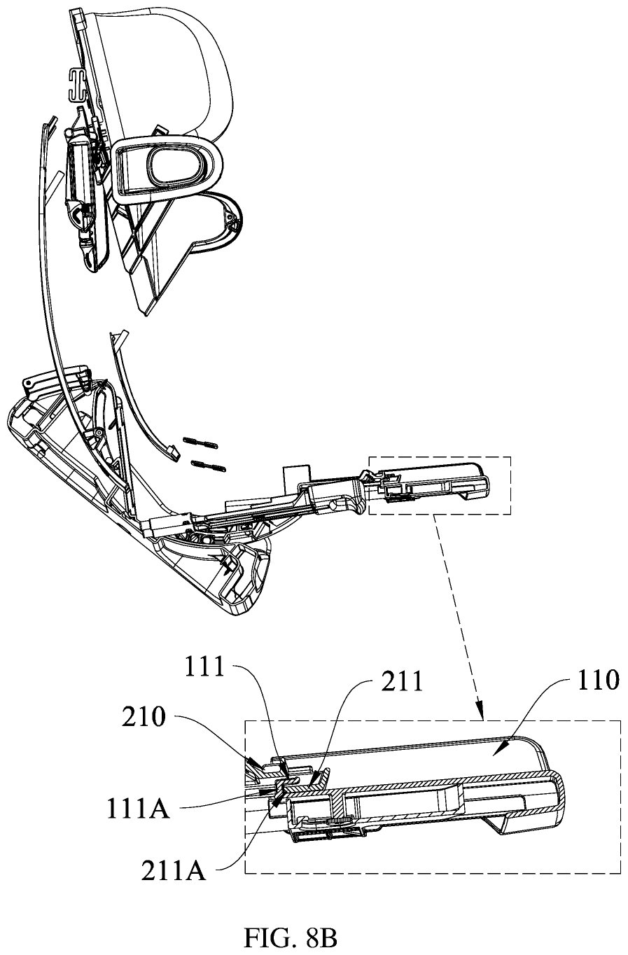

In order to prevent the support plate 100 from disengaging from the seat part 200, the support plate 100 may also be provided with a limiting mechanism, for example, the limiting mechanism may include a limiting rib and a limiting slot. Specifically, in the embodiment shown in FIGS. 8A and 8B, the body 110 of the support plate 100 may also be provided with a limiting rib 111. At the same time, the seat part 200 may include a cover 210 at the front side, and the cover 210 is provided with a limiting slot 211. When the support plate 100 slides to the furthest extended position, the limiting rib 111 on the body 110 may be blocked by the limiting slot 211 on the cover 210, thereby preventing the support plate 100 from continuing to slide forward and disengaging from the seat part 200. More specifically, referring to FIG. 8B, when the support plate 100 may slide to the furthest extended position, a vertical segment 111A of the limiting rib 111 may be blocked by the blocking part 211A of the limiting slot 211, so that the body of the support plate 100 may be restricted.

In addition, a child safety seat may also be provided in another embodiment of the present disclosure.

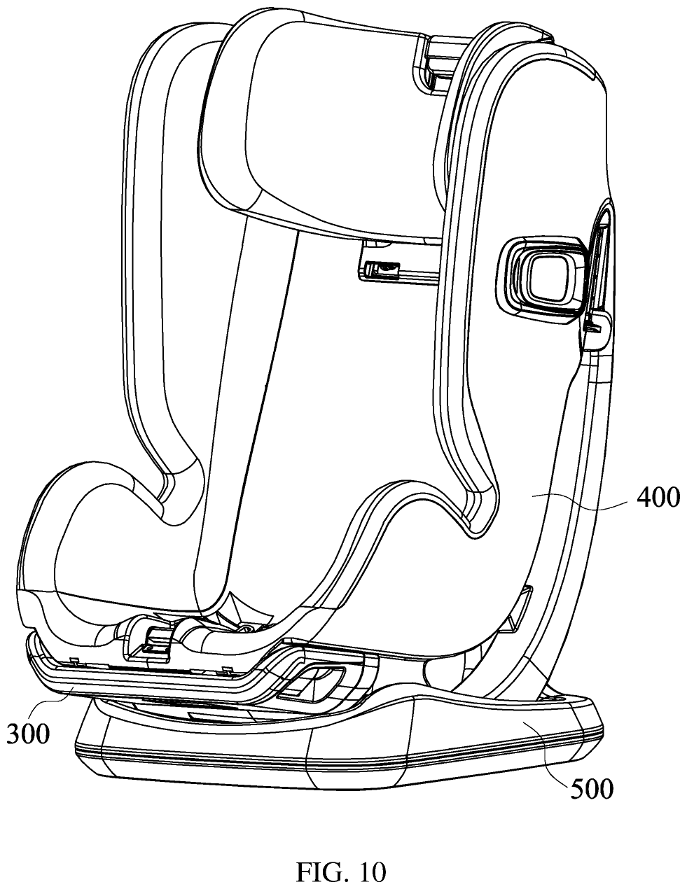

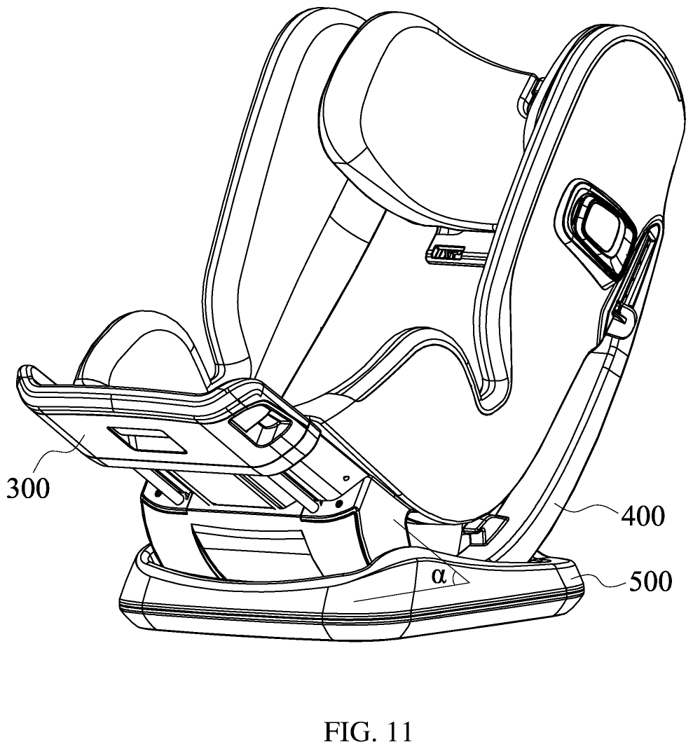

Referring to FIGS. 10 and 11, FIGS. 10 and 11 respectively show different states of the child safety seat and a support plate 300 provided thereon according to another embodiment of the present disclosure.

Specifically, the child safety seat of this embodiment may include a seat part 400 in which a child sits and a base 500 to which the seat part 400 is provided. The seat part 400 may be slidable with respect to the base 500, and may be at different angles a with respect to the base 500, wherein a is greater than or equal to 0. It should be noted that “the seat part 400 may be at the angle a with respect to the base 500” as described herein refers to an angle of a plane as defined by a position of the seat part 400 in which the child sits or a bottom plane of the seat part 400 with respect to the base 500 (for example, a plane for supporting the seat part 400). For example, FIGS. 10 and 11 respectively show the seat part 400 may have two different angles with respect to the base 500, that is, the seat part 400 shown in FIG. 10 is substantially parallel to the base 500, i.e., a is substantially equal to 0; and the angle a of the seat part 400 with respect to the base 500 shown in FIG. 11 is greater than 0, for example about 30° to 40°. Of course, the present disclosure may not be limited thereto.

Similar to the embodiment shown in FIG. 1, the child safety seat according to another embodiment of the present disclosure may also be provided with a support plate 300. As shown in FIGS. 10 and 11, the support plate 300 may be slidably connected to the seat part 400 to be telescopic from the front end of the seat part 400, so that it may abut against the backrest of the vehicle seat, for example, when the child safety seat is used in a rear-facing mode, and then prevent the child safety seat from being overturned; and at the same time, the support plate 300 may also provide support for legs of the child sitting on the seat part 400. For example, the support plate 300 of this embodiment may be slidable and may be positioned between the retracted position shown in FIG. 10 and the extended position shown in FIG. 11. Hereinafter, the specific structure and arrangement of the support plate 300 in this embodiment will be described in detail in the description of FIGS. 14 to 19.

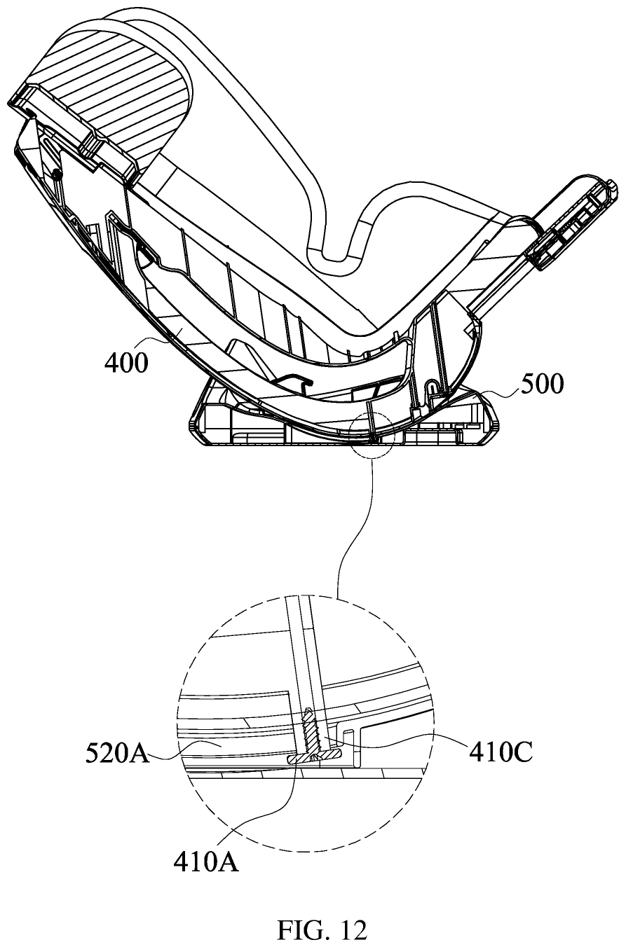

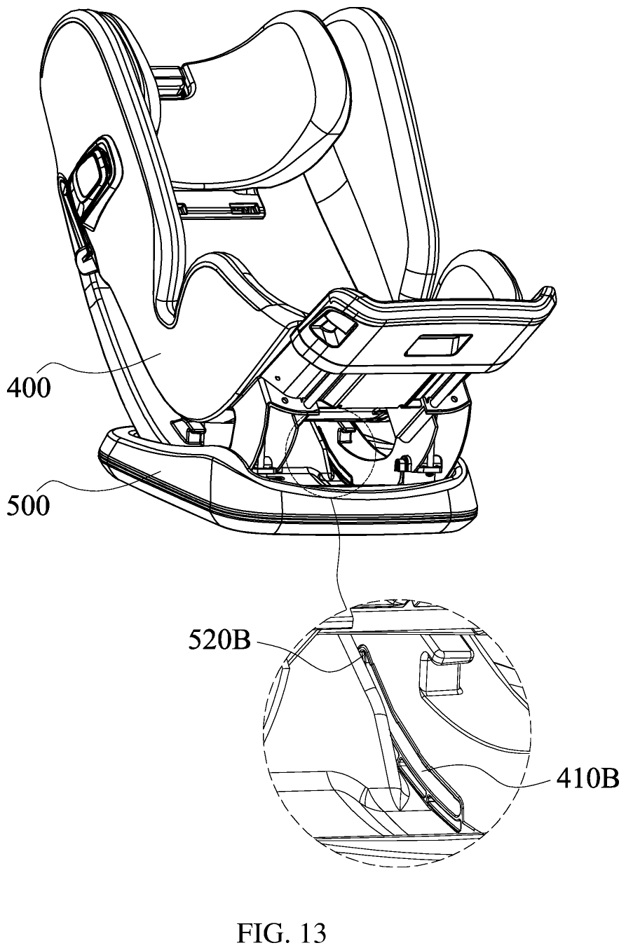

Referring to FIGS. 12 and 13, FIG. 12 shows a side cross-sectional view of the child safety seat shown in FIG. 11, and FIG. 13 shows a perspective view of the child safety seat viewed from another angle.

The seat part 400 and the base 500 of the child safety seat of the present disclosure may be slidable to each other. Specifically, the seat part 400 and the base 500 can be slidably connected through components cooperated with each other. For example, FIG. 12 shows a sliding connection between the seat part 400 and the base 500 according to an example, and FIG. 13 shows a sliding connection between the seat part 400 and the base 500 according to another example.

As shown in FIGS. 12 and 13, the seat part 400 is slidably connected with the base 500 through at least one sliding assembly. Each of the sliding assemblies may include sliding members 410A, 410B and sliding-fit members 520A, 520B. The sliding members 410A, 410B may be provided to the seat part 400. The sliding-fit members 520A, 520B may be disposed to the base 500 and slidingly fit to the sliding members 410A, 410B, respectively.

In an example, as shown in FIG. 12, the sliding member 410A is a screw fixed to the bottom of the seat part 400 through a connecting column 410C, and the sliding-fit member 520A may be an arc-shaped elongated slot extending on the upper surface of the base 500 along a direction in which the seat part 400 slides with respect to the base 500. In a preferred example, at least one arc-shaped elongated slot may be provided on the bottom side of the seat part 400. At least one arc-shaped elongated slot may be provided at the bottom side of the seat part 400, at the bottom surface of the seat part 400 in contact with the base 500, and a combination of at least one connecting column and at least one screw may be correspondingly provided on the upper surface of the base 500. Specifically, a connecting column 410C (such as a columnar structure with a threaded hole) may be fixedly arranged on the bottom side of the seat part 400. The connecting column 410C may extend into the arc-shaped elongated slot of the base 500, and the screw is connected with the connecting column 410C so that the screw, together with the connecting column 410C, may slide along the arc-shaped elongated slot, such that the sliding connection between the seat part 400 and the base 500 can be realized. Preferably, a diameter of a head of the screw is greater than a width of the arc-shaped elongated slot on the upper surface of the base 500, and optionally, a cross-sectional shape of the arc-shaped elongated slot may be adapted to a cross-sectional shape of the screw and the connecting column 410C, such as an inverted T shape, so that the seat part 400 may be slidably connected to the base 500 without being disengaged in a direction perpendicular to a sliding direction thereof. That is, during the seat part 400 is slidable with respect to the base 500, the screw and connecting column may not disengage from the arc-shaped elongated slot. It should be noted that the present disclosure is not limited to the number of arc-shaped elongated slots, connecting columns and screws as mentioned above or as shown in the figures, two or more arc-shaped elongated slots may also be provided, and a corresponding number of connecting columns and screws may be provided correspondingly. In addition, in other examples, the connecting columns and screws may also be provided on the base 500, while the arc-shaped elongated slots may be provided on the seat part 400. Furthermore, the present disclosure may only provide the connecting column 410C (i.e., without a screw), and the shape of the connecting column 410C may be a hollow cylinder, cuboid, trapezoid, etc., but the present disclosure may not be limited thereto.

In another example, as shown in FIG. 13, the sliding member 410B may be an arc-shaped sliding slot provided on a bottom side surface of the seat part 400, and the sliding-fit member 520B may be an inserting pin correspondingly provided on the base 500. Preferably, at least two arc-shaped sliding slots may be provided on the side surface of the seat part 400 in contact with the base 500, and at least two inserting pines may be correspondingly provided on the base 500. For example, an arc-shaped sliding slot may be provided on each of two inside surfaces of the seat part 400, and an inserting pin may be correspondingly provided at a position of the base 500 in matched with the inside surface of the seat part 400. Of course, the present disclosure may not be limited thereto. In other examples, positions of the arc-shaped sliding slot and the inserting pin may be interchanged, that is, the arc-shaped sliding slot may be provided on the base 500, and the inserting pin may be provided on the seat part 400. Optionally, a single inserting pin may be provided on the seat part 400, and two ends of the single inserting pin may be exposed to both sides of the seat part 400, and cooperate with the arc-shaped sliding slots of the base 500, respectively.

It should be noted that both of the sliding member 410A and the sliding-fit member 520A and the sliding member 410B and the sliding-fit member 520B of the above-mentioned two examples may be provided at the same time, to further increase the stability of the sliding connection between the seat part and the base. Of course, the present disclosure may not be limited thereto, and other sliding connection manners may also be adopted or combined.

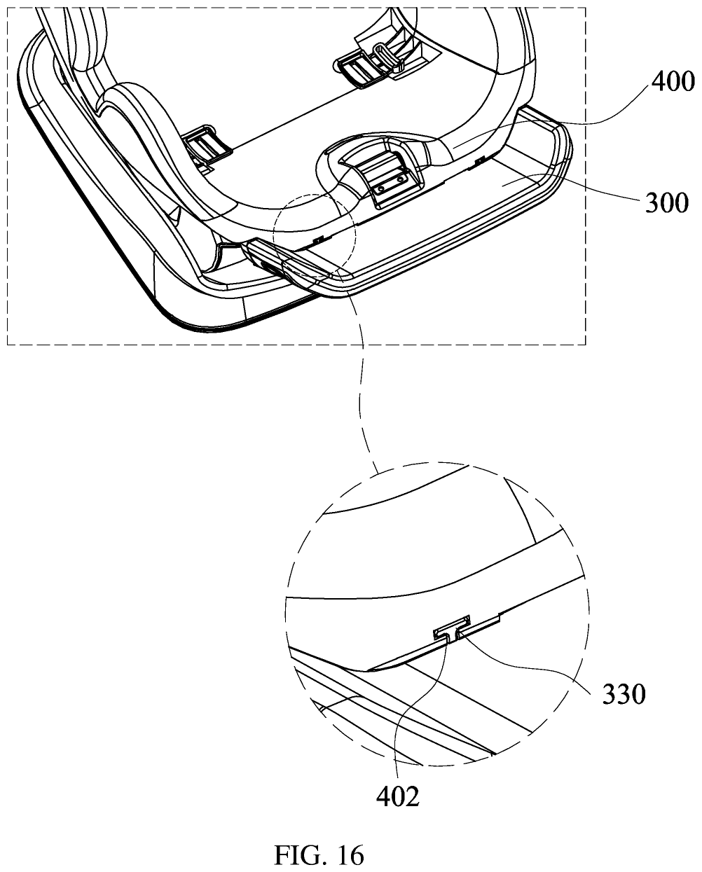

Referring to FIGS. 14 to 16, FIG. 14 shows the child safety seat according to another embodiment of the present disclosure viewed from another different angle, FIG. 15 shows a structural schematic view of the support plate 300, and FIG. 16 shows a partial perspective view of the child safety seat, showing a connection manner between the seat part 400 and the support plate 300.

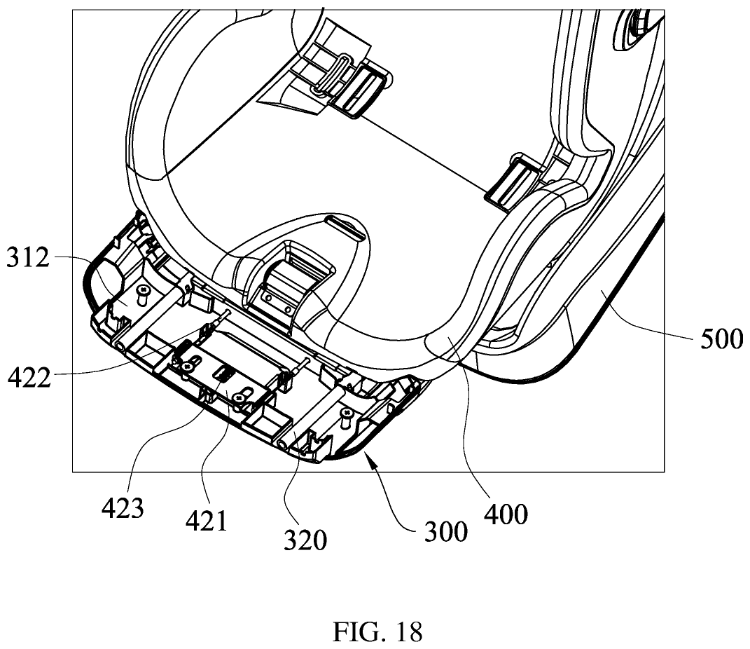

As shown in FIG. 14, the support plate 300 may be slidably provided on the seat part 400, and may be extended and retracted from the front end of the seat part 400. Further referring to FIGS. 14 and 15, the support plate 300 may include a body 310 and a connecting element 320. In an example, the body 310 of the support plate 300 may be formed by connecting an upper cover 311, a lower cover 312 and a bottom plate 313, wherein the upper cover 311 and the lower cover 312 may form a part of the support plate 300 exposed from the seat part 400, and the bottom plate 313 may be connected to a rear end of the upper cover 311 and a rear end of the lower cover 312 and located therebetween. In an example, the bottom plate 313 may have an extension 313a extending rearwards by a certain length from a shell formed by the upper cover 311 and the lower cover 312, which can facilitate enhancing the stability of the support plate 300 when sliding with respect to the seat part 400. In an example, two connecting elements 320 may be provided, wherein the two connecting elements 320 may be symmetrically arranged on left and right sides of the body 310, and the extension 313a may be located between the two connecting elements 320. Preferably, the extension 313a may be a sheet structure. At least a portion of the connecting element 320 may be fixed on the body 310, and the other part thereof may extend from the body 310 to be slidably inserted into a connecting hole 401 which is correspondingly provided on the seat part 400 and has a complementary shape, so that the support plate 300 may be slidably connected to seat part 400. In an example, as shown in FIG. 15, a length of the extension 313a may be less than a length of the connecting element 320 extending from the body 310 (for example, from the shell formed by the upper cover 311 and the lower cover 312). More specifically, at least a portion of the connecting element 320 may be fixedly connected to the bottom plate 313 of the support plate 300 by a rivet, and the specific connection between the connecting element 320 and the body 310 may be not shown in FIGS. 14 to 16 since the cover of the support plate 300 is blocked, please refer to the subsequent FIG. 18.

In addition, the connecting element 320 in this embodiment may be in a shape of a circular tube, a square tube, a circular rod, or a square rod, etc., and the present disclosure is not limited to the above embodiments, and there may be one, three or more than three connecting elements.

In an example, as shown in FIGS. 15 and 16, the support plate 300 further includes a first sliding element 330 slidingly fit to a second sliding element 402 provided on the seat part 400 correspondingly, to further enhance the sliding connection between the support plate 300 and the seat part 400. In a preferred example, the first sliding element 330 may be disposed on the upper surface of the support plate 300, and more specifically on the body 310 of the support plate 300. More preferably, as shown in FIG. 16, one of the first sliding element 330 and the second sliding element 402 is a sliding rib, such as a T-shaped or L-shaped sliding rib or the like, and the other one of the first sliding element 330 and the second sliding element 402 is a sliding slot, such as a T-shaped or L-shaped sliding slot or the like. In addition, the first sliding element 330 and the second sliding element 402 may also adopt other sliding-fit structures, such as a sliding rod and a sliding ring, as long as the support plate 300 may be slidable with respect to the seat part 400. In addition, although only two first sliding elements 330 in this embodiment are shown in FIG. 15, it should be understood for those skilled in the art that other numbers, such as one, three, four of the first sliding elements 330 may also be provided. It should be noted that the first sliding element 330 may be configured such that the support plate 300 can never protrude from the seat part 400 in order to avoid interfering with or catching clothes of the children during the support plate 300 is slidable with respect to the seat part 400.

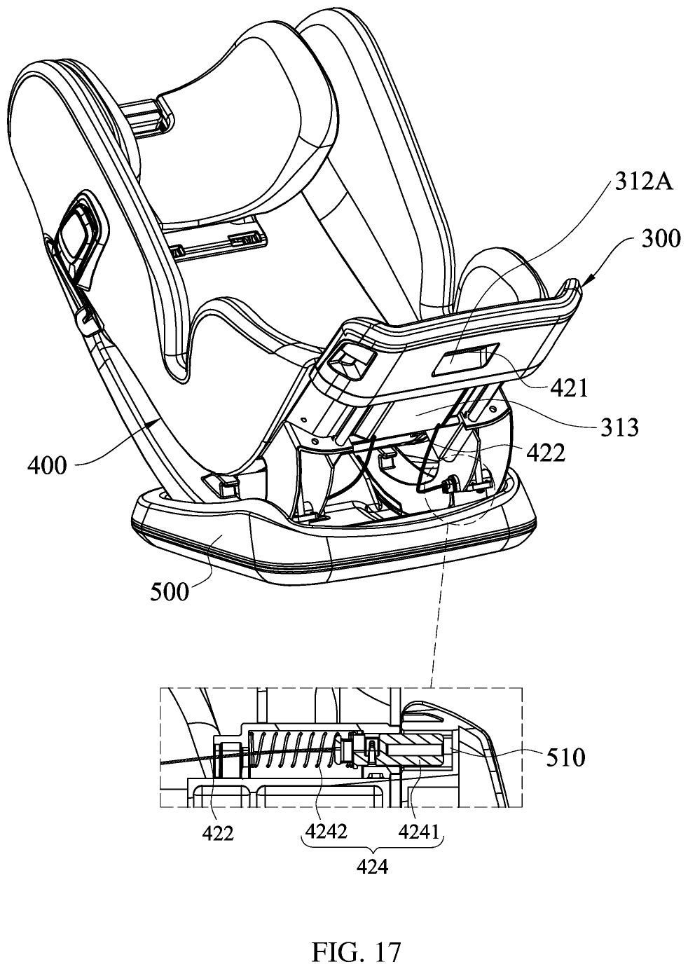

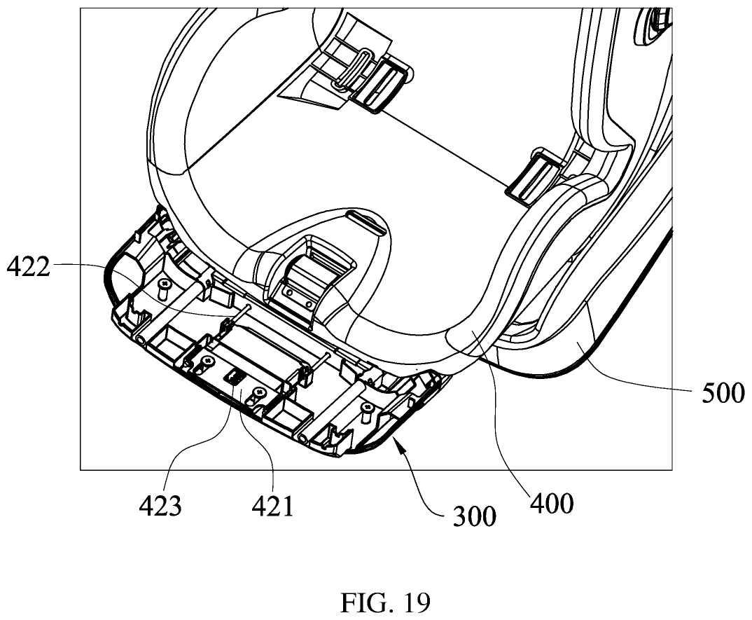

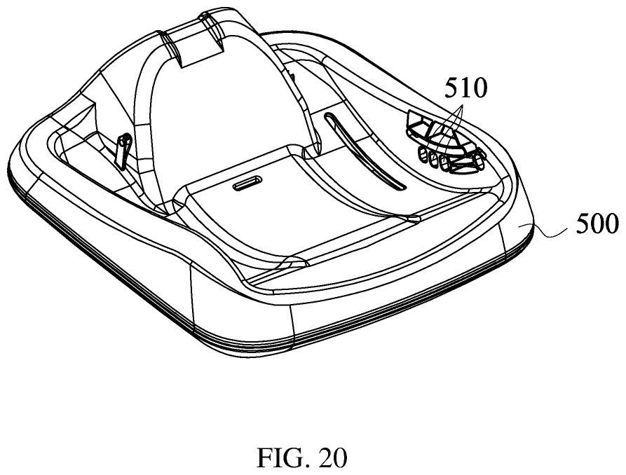

Referring to FIGS. 17 to 20, FIG. 17 shows a perspective view of the child safety seat according to another aspect of the present disclosure, in which a bottom cover plate between the support plate 300 and the seat part 400 is removed; FIGS. 18 and 19 respectively show a partial perspective view of the child safety seat viewed from above, in which the upper cover 311 of the support plate 300 is removed to show the internal structure of the support plate 300, more specifically, FIG. 18 shows that an unlocking operating member 421 of a seat angle adjustment mechanism is in a locking position, and FIG. 19 shows that the unlocking operating member 421 of the seat angle adjustment mechanism is in an unlocking position; and FIG. 20 shows the base 500 provided with a locking hole 510 in matched with a seat angle adjustment mechanism.

In order to increase comfort of the child safety seat, the child safety seat may also be provided with a seat angle adjustment mechanism, that is, a mechanism capable of adjusting an angle of the seat part 400 of the child safety seat with respect to the base 500. Specifically, the seat angle adjustment mechanism may be provided between the seat part 400 and the base 500 to adjust the angle, such as an angle a shown in FIG. 11 of the seat part 400 with respect to the base 500.

As shown in FIGS. 17 to 19, the seat angle adjustment mechanism may include an unlocking operating member 421, a connecting member 422 and an angle locking structure 424. The unlocking operating member 421 may be disposed on the support plate 300 connected to the front end of the seat part 400, and may be operated to move between an unlocking position (as shown in FIG. 19) and a locking position (as shown in FIG. 18). In an example, the unlocking operating member 421 may be slidably disposed on the support plate 300, and at least partially exposed from the support plate 300 in order to be operated from the outside. More specifically, as shown in FIG. 17, the unlocking operating member 421 is disposed on a lower side of the front end of the support plate 300, and at least partially exposed from the lower side of the support plate 300. For example, the lower cover 312 of the support plate 300 may be provided with a window 312A at a position corresponding to the unlocking operating member 421, and the user can operate the unlocking operating member 421 from the window 312A to avoid interference or misoperation caused by the unlocking operating member 421 protruding from the lower side of the support plate 300. In addition, the unlocking operating member 421 of the present disclosure may be not limited to the above-mentioned positions, that is, it may also be disposed at other positions of the support plate 300, such as any sides or upper surfaces of the support plate 300, and optionally, although only one unlocking operating member 421 is shown in FIG. 17, it should be understood that a plurality of unlocking operating members 421 may also be provided. For example, one unlocking operating member 421 may be provided on each of both sides of the support plate 300, and any one of unlocking operating members 421 may be operated to adjust the angle locking structure 424, and even adjust a plurality of angle locking structures 424 synchronously.

The connecting member 422 may be connected between the unlocking operating member 421 and the angle locking structure 424, and the angle locking structure 424 may be disposed between the seat part 400 and the base 500 to lock or unlock the seat part 400 with respect to the base 500. Referring to FIGS. 17 and 18, one end of the connecting member 422 may be fixedly connected to the unlocking operating member 421, and the other end thereof may be fixedly connected to the angle locking structure 424, so that the angle locking structure 424 may unlock the seat part 400 and the base 500 under the traction of the connecting member 422 while operating the unlocking operating member 421. In a specific example, the connecting member 422 may be a flexible element, such as a steel wire, to avoid interfering the extension and retraction of the support plate 300. More specifically, referring to a part where the bottom cover plate of the seat part 400 is removed in FIG. 17, the other end of the connecting member 422 may pass through the support plate 300 and may be connected to the angle locking structure 424.

In an example, a receiving slot 3131 for fixing the connecting member 422 may also be provided on the extension 313a (such as a sheet structure) of the bottom plate 313 of the support plate 300. The number of receiving slots 3131 corresponds to the number of connecting members 422, particularly referring to FIG. 15. For example, referring to FIGS. 15 and 17, two receiving slots 3131 may be symmetrically disposed at intervals on the extension 313a to respectively receive a corresponding connecting member 422 therein. Therefore, in addition to enhancing the sliding stability of the support plate 300, the extension 313a may also block the connecting member 422, to prevent the connecting member 422 from being interfered by external devices and make the appearance of the child safety seat neat. For example, the receiving slot 3131 may be in a U-shaped structure with an opening facing towards the seat part 400. However, the present disclosure may not be limited thereto, that is, the receiving slot 3131 may also have other shapes, as long as it can receive the connecting member 422.

In an example, a plurality of connecting members 422 and a plurality of angle locking structures 424 may be provided. In this embodiment, two connecting members 422 and two angle locking structures 424 may be taken as an example. As shown in FIG. 17, two angle locking structures 424 are respectively arranged on the inner sides of the seat part 400 facing towards each other and are located on the front side of the sliding assembly. Each of the connecting members 422 may have one end connected to one of the parts symmetrical to each other of the unlocking operating member 421 and the other end connected to one of the angle locking structures 424. More specifically, the connecting member 422 may extend from the unlocking operating member 421 through the receiving slot 3131 of the support plate 300, and then extend from the support plate 300 and connected to one end of the angle locking structure 424, in order to control the two angle locking structures 424 synchronously through the unlocking operating member 421.

In an example, as shown in FIGS. 18 and 19, the seat angle adjustment mechanism may further include a reset member 423, the reset member 423 may be disposed between the unlocking operating member 421 and the support plate 300, and constantly provide a force to make the unlocking operating member 421 in the locking position or return to the locking position.

In addition, the angle locking structure 424 may have a plurality of locking positions with respect to the base 500, so that the seat part 400 may be locked at several angles with respect to the base 500, so as to realize the angle adjustment of the child safety seat.

As shown in FIG. 17, the angle locking structure 424 may include an engaging pin 4241 which may be movably disposed on the seat part 400. Specifically, as shown in FIG. 17, one end of the locking pin 4241 may be linked with the unlocking operating member 421 through the connecting member 422, and may be engaged with at least one engaging hole 510 provided on the base 500. Preferably, as shown in FIGS. 17 and 20, the base 500 may be provided with a plurality of engaging holes 510, so that the engaging pin 4241 may be engaged with one of the engaging holes 510 provided on the base 500 with the variation of angles of the seat part 400 relative to the base 500. It should be noted that only three engaging holes 510 are shown in FIG. 20, but the present disclosure may not be limited thereto. That is, the base 500 may also be provided with further more engaging holes, such as four, five, six, etc., to provide a fine angle adjustment.

Moreover, the angle locking structure 424 may also include an engaging reset member 4242 that may be disposed between the seat part 400 and the engaging pin 4241 to bias the engaging pin 4241 towards the corresponding engaging hole 51, that is, constantly providing a force to allow the engaging pin 4241 to engage with the corresponding engaging hole 510.

It should be noted that although the seat angle adjustment structure in this embodiment may be disposed to fit to the support plate 300, the present disclosure may not be limited thereto, and the seat angle adjustment structure may also be fit to that in the embodiment described above in combination with FIGS. 4 to 7B, that is, the unlocking operating member 421 of the seat angle adjustment structure may also be disposed on the support plate 100 in the foregoing embodiments, for example, on its front end, either side, or the like. In addition, it should also be understood that the seat angle adjustment structure may also be used in cooperation with a non-adjustable support plate, that is, the unlocking operating member 421 of the seat angle adjustment structure may be disposed on a seat with the non-adjustable support plate. Such configuration can also facilitate the user not to be blocked by the support plate 300 when it is required to operate the unlocking operating member 421 to adjust an angle of the seat.

The principle of the seat angle adjustment mechanism will be specifically described below by taking the angle locking structure 424 shown in FIGS. 17 to 19 as an example.

Prior to adjusting the angle of the seat, as shown in FIGS. 17 and 18, the unlocking operating member 421 may be in the locking position, the seat part 400 may be positioned with respect to the base 500, and the engaging pin 4241 of the angle locking structure 424 may be engaged with the engaging hole 510 on the base 500 under the elastic action of the engaging reset member 4242.

When the adjustment of the angle of the seat is required, the user may operate the unlocking operating member 421 to the unlocking position (as shown in FIG. 17) in a direction of resisting the reset member 423, for example, by pressing the unlocking operating member 421 from the window 213A (see FIG. 17) on the support plate 300 to pull the connecting member 422, so that the engaging pin 4241 can resist the elastic effect of the engaging reset member 4242 to disengage from the engaging hole 510 under the traction of the connecting member 422. At this time, the seat part 400 may be unlocked from the base 500 and may be slidable with respect to the base 500 so as to be adjusted to a desired angle.

When the seat may be adjusted to the desired angle, the user may release the unlocking operating member 421, the unlocking operating member 421 may return to the locking position as shown in FIG. 18 under the elastic action of the reset member 423, and the engaging pin 4241 may return to an engaging position as shown in FIG. 17 under the elastic action of the engaging reset member 4242. Preferably, an elastic force of the engaging reset member 4242 may be greater than an elastic force of the reset member 423, so that the connecting member 422 can always be maintained in a tensioned state.

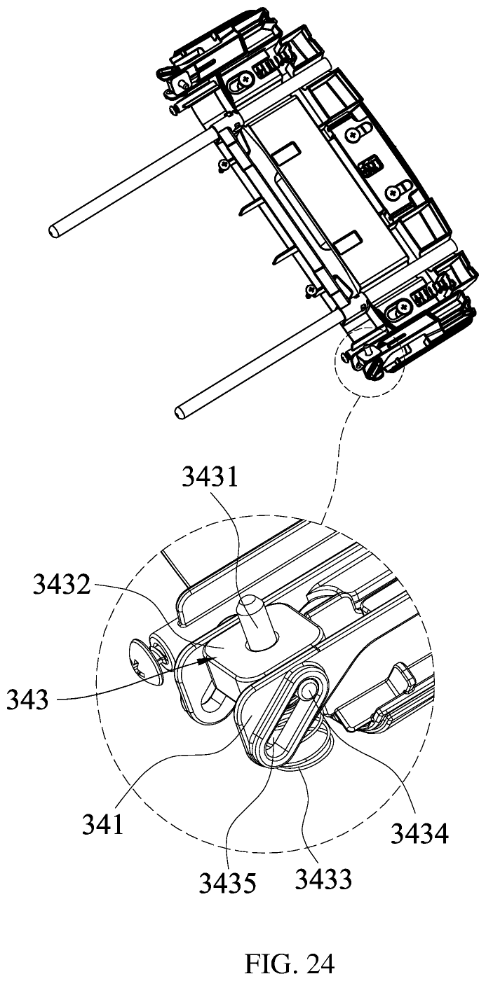

Referring to FIGS. 21 to 24, FIG. 21 shows another partial perspective view of the child safety seat according to another aspect of the present disclosure, in which the upper cover 311 of the support plate 300 is removed to show the internal structure of the support plate 300; FIG. 22 shows a top partial perspective view of the support plate 300 and the seat part 400; FIG. 23 shows a cross-sectional view taken along a line “D-D” in FIG. 22; and FIG. 24 shows a perspective view of the support plate 300, in which the upper cover 311 and the bottom plate 313 are removed.

In order to further improve the comfort of the child safety seat, adapt to different vehicle models better, and provide support for different legs of children, a support plate adjustment mechanism 340 may also be provided on the support plate 300 to adjust a telescopic position of the support plate 300 with respect to the seat part 400, that is, adjust a length of the support plate 300 extending from the seat part 400.

In an example, the support plate adjustment mechanism 340 may include an operating element 341 and a positioning structure 343. For ease of understanding, FIG. 21 mainly shows the structure of the operating element 341 without the positioning structure 343, FIG. 22 shows the positioning method between the support plate 300 and the seat part 400, and FIGS. 23 and 24 show connection and cooperation between the positioning structure 343 and the operating element 341.

As shown in FIG. 21, the operating element 341 may be slidably disposed on the support plate 300, and may be slidable between a locking position (see FIG. 21) and a releasing position (not shown). Referring to FIG. 14, the operating element 341 may be at least partially exposed from the support plate 300. For example, the operating element 341 may be configured as a member spanning the inside of the support plate 300 and having left and right ends respectively exposed to both sides of the support plate 300, to form an adjusting end on either side of the support plate 300. Thus, the user can operate the operating element 341 through the adjusting end on either side of the support plate 300. Similarly, a window may also be provided on either side of the support plate 300, to prevent unnecessary interference caused by the two adjusting ends protruding from the outer surface of the support plate 300.

In an example, the support plate adjustment mechanism 340 may further include an elastic element 342. The elastic element 342 may be disposed between the operating element 341 and the support plate 300 to bias the operating element 341 towards the locking position, that is, constantly providing a force to allow the operating element 341 be at or return to the locking position. More specifically, one end of the elastic element 342 may abut against the operating element 341, and the other end thereof may abut against the inner side of the lower cover 312 of the support plate 300. For example, as shown in FIG. 21, two elastic elements 342 may be symmetrically arranged on the support plate 300 in a left-right direction. More preferably, the two elastic elements 342 may be respectively arranged at left and right ends of the operating element 341 of the support plate 300, so that the operating element 341 may be stably slidable with respect to the support plate 300 until it returns to the locking position.

Further referring to FIGS. 22 to 24, the positioning structure 343 may be disposed on the support plate 300 and linked with the operating element 341 to position the support plate 300 in at least one position of the seat part 400. When the operating element 341 may be in the locking position, the positioning structure 343 may be locked, so that the support plate 300 may be positioned with respect to the seat part 400. When the operating element 341 may be operated to the releasing position (not shown), the positioning structure 343 may be operated to be unlocked, so that the support plate 300 may move with respect to the seat part 400.

In an example, as shown in FIGS. 22 and 23, the positioning structure 343 may include a first locking element 3431, and the first locking element 3431 may be disposed at an end of the support plate 300 adjacent to the seat part 400. As the operating element 341 is movable between the locking position and the releasing position, the first locking element 3431 may be engaged with the second locking element 430 correspondingly provided on the seat part 400 (that is, the first locking element 3431 is in the locking position) or disengaged from the second locking element 430 (that is, the first locking element 3431 is in the unlocking position). In this embodiment, as an example, the first locking element 3431 may be configured as a positioning pin and the second locking element 430 may be configured as a positioning slot. More specifically, two positioning slots are shown in FIG. 22, but the present disclosure may not be limited thereto, more positioning slots may also be provided to provide fine position adjustment.

More specifically, as shown in FIGS. 23 and 24, the first locking element 3431 may be fixedly disposed on a fixing seat 3432 at the end of the support plate 300, and the operating element 341 may be provided with an inclined slot 3435 that may be slidingly fit to the fixing seat 3432. For example, the inclined slot 3435 may be located at one end of the operating element 341, such as an end opposite to an operated end (i.e., an end exposed from the support plate 300) as shown in FIG. 23, and may be slidably connected to the fixing seat 3432 through linkage pins 3434 provided at both sides of the fixing seat 3432. In an example, the linkage pin 3434 may be integrally formed with the fixing seat 3432, and protrude from either side of the fixing seat 3432. However, the present disclosure may not be limited thereto. For example, in other embodiments, the linkage pin 3434 may also be a pin that may be inserted into the fixing seat 3432 and protrude from either side of the fixing seat 3432.

It can be seen from FIG. 24 that when the operating element 341 is operated to move from the locking position to the releasing position (not shown), the operating element 341 may drive the inclined slot 3435 at an end thereof to move forward, and then the fixing seat 3432 may move downward along with the movement of the linkage pin 3434 in the inclined slot 3435, thereby driving the first locking element 3431 to disengage from the seat part 400. At this time, the support plate 300 may be slidable with respect to the seat part 400.

In an example, a return spring 3433 may also be provided between the fixing seat 3432 and the support plate 300 (such as the lower cover 312 of the support plate 300) to assist the first locking element 3431 to maintain or return to a position engaged with the seat part 400.

By adjusting the length of the support plate 300 protruding from the seat part 400, the support plate 300 may abut against a backrest in any different vehicles, to make the connection of the child safety seat more firm; in addition, by adjusting the length of the support plate 300 protruding from the seat part 400, different leg spaces for children sitting on the seat part 400 can be provided to satisfy the children in different heights.

The present disclosure has beneficial effects as follows: the seat angle adjustment mechanism may be provided on the child safety seat to adjust an angle of the seat, that is, an angle of the seat part with respect to the base, so as to improve the comfort of the child safety seat. At the same time, the unlocking operating member of the seat angle adjustment mechanism may be disposed on the support plate, so that the operation of the seat angle adjustment mechanism can be convenient and cannot be interfered by the extension and retraction of the support plate, thereby improving the convenience of the seat angle operation, and further improving user's satisfaction. In addition, such a seat angle adjustment mechanism has a simple structure, is convenient for production and processing, and has low cost. Thus, the present disclosure can solve a problem of the seat angle adjustment mechanism in the prior art, that is, since operation buttons are generally provided at the front end of the seat, when the support plate protrudes from the front end of the seat, the seat angle adjustment button will be shield and difficult to be found, or the user's hand can be blocked to touch the button to cause inconvenience.

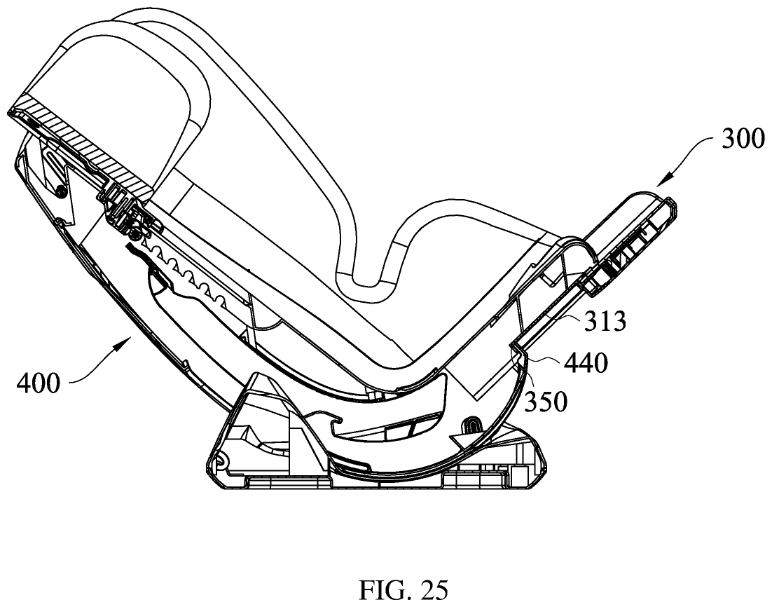

Referring to FIG. 25, another side cross-sectional view of the child safety seat according to another aspect of the present disclosure is shown. In order to prevent the support plate 100 from disengaging from the seat part 200, a limiting mechanism may also be provided on the support plate 300, for example, the limiting mechanism may be composed of two limiting pieces. Specifically, as shown in FIG. 25, the support plate 300 may also be provided with a first limiting piece 350, and the seat part 400 may be correspondingly provided with a second limiting piece 440. Specifically, the first limiting piece 350 may be disposed on the bottom plate 313. For example, the first limiting piece 350 may fixed to one end (which is opposite to an end protruding from the seat part 400) of the support plate 300 and extend by a certain distance along a direction perpendicular to the support plate 300 from the end thereof. Through the cooperation of the first limiting piece 350 and the second limiting piece 440, a stroke of the support plate 300 extending from the seat part 400 can be limited and is less than or equal to a distance by which one end of the support plate 300 extends.

Specifically, it can be seen from FIG. 25 that when the support plate 300 is pulled forward under the seat part 400, the first limiting piece 350 moves forward along with the support plate 300, until it abuts against the second limiting piece 440, to limit the further movement of the support plate 300 and thus prevent the support plate 300 from being separated from the seat part 400.

Although relative terms such as “upper” and “lower” are used in this specification to describe the relative relationship of one component to another component in the drawings, these terms are used in this specification only for convenience, such as directions in the examples described according to the drawings. It can be appreciated that if the illustrated device is turned over to be upside down, a component described as being “upper” will become a component that is “lower”. Other relative terms, such as “top”, “bottom”, “left”, “right”, etc. also have similar meanings. When a structure is “on” another structure, it may refer to a structure integrally formed on another structure, or refer to a structure “directly” provided on another structure, or a structure “indirectly” provided on another structure through other structure(s).

In this specification, the terms “a”, “an”, “the”, “said” and “at least one” are used to indicate the presence of one or more elements/components and the like; the terms “comprising”, “including” and “having” are used to indicate an open-ended inclusive meaning and mean that there may be additional elements/components and the like in addition to the listed elements/components and the like; the terms “first”, “second”, “third” and the like are used only as marks, not as restrictions on the number of their objects.

Unless otherwise defined, all terms including technical and scientific terms used herein have the same meaning as commonly understood by those ordinary skilled in the art to which the present disclosure belongs. It should also be understood that terms should be interpreted to have a meaning consistent with their meaning in the context of the related art, and will not be interpreted in an idealized or overly formal sense unless expressly defined herein.

It should be understood that, while preferred embodiments have been shown and described above, the present disclosure is not limited to the specific embodiments described above. Various modifications and variations can be made by those skilled in the art without departing from the spirit and scope of the appended claims. Therefore, it should be noted that various modifications and variations cannot be considered as departing from the technical spirit and scope of the present disclosure.

1. A child safety seat, comprising:
a seat part;
a support plate provided on the seat part, and slidable with respect to the seat part, such that the support plate is telescopic from the front end of the seat part;
a support plate adjustment mechanism for adjusting a length of the support plate extending from the seat part;
a base for seating the seat part; and
a seat angle adjustment mechanism provided between the seat part and the base for adjusting an angle of the seat part with respect to the base, wherein the seat angle adjustment mechanism comprises:
an unlocking operating member provided on the support plate, capable of sliding with the support plate and capable of being operated to move between an unlocking position and a locking position;
an angle locking structure provided between the seat part and the base to lock or unlock the seat part with respect to the base, wherein the angle locking structure has a plurality of locking positions with respect to the base to lock the seat part at a plurality of angles with respect to the base; and
a connecting member connected between the unlocking operating member and the angle locking structure,
wherein when the unlocking operating member is in the locking position, the seat part is positioned with respect to the base; and when the unlocking operating member is operated to the unlocking position, the seat part is slidable with respect to the base.

2. The child safety seat according to claim 1, wherein the unlocking operating member is slidably provided on the support plate, and is at least partially exposed from the support plate; and
the unlocking operating member is provided on a lower side of a front end of the support plate, and is at least partially exposed from the lower side of the support plate.

3. The child safety seat according to claim 1, wherein the seat angle adjustment mechanism further comprises:
a reset member provided between the unlocking operating member and the support plate and biasing the unlocking operating member towards the locking position.

4. The child safety seat according to claim 1, wherein the angle locking structure comprises:
an engaging pin movably provided on the seat part, wherein one end of the engaging pin is linked with the unlocking operating member through the connecting member, so that the engaging pin is capable of being engaged with at least one engaging hole provided on the base with variations of angles of the seat part relative to the base-; and
the angle locking structure further comprises:
an engaging reset member provided between the seat part and the engaging pin to bias the engaging pin towards a corresponding one of the engaging holes.

5. (canceled)

6. The seat angle adjustment mechanism according to claim 1, wherein the connecting member is a flexible element, one end of the connecting member is fixedly connected to the unlocking operating member which provided on the support plate, and the other end of the connecting member is fixedly connected to the angle locking structure which provided on between the seat part and the base

7. (canceled)

8. The child safety seat according to claim 1, wherein the seat part is slidably connected to the base through at least one sliding assembly, wherein the sliding assembly or each of the sliding assemblies comprises:
a sliding member provided on the seat part; and
a sliding-fit member provided on the base and slidingly fit to the sliding member.

9. The child safety seat according to claim 8, wherein the sliding member is a screw fixed to a bottom of the seat part through a connecting column, and the sliding-fit member is an arc-shaped elongated slot extending along a direction in which the seat part slides with respect to the base on an upper surface of the base; and
the sliding member is an arc-shaped sliding slot provided on a bottom side surface of the seat part, and the sliding-fit member is an inserting pin correspondingly provided on the base.

10. (canceled)

11. The child safety seat according to claim 1, wherein the support plate comprises a body, the body is formed by connecting an upper cover, a lower cover and a bottom plate, the upper cover and the lower cover form a part of the support plate exposed to the seat part, and the bottom plate is connected to a rear end of the upper cover and a rear end of the lower cover and located between the upper cover and the lower cover;
the bottom plate has an extension provided with a receiving slot for fixing the connecting member of the seat angle adjustment mechanism.

12. The child safety seat according to claim 1, wherein the support plate comprises:
a body;
a connecting element, wherein at least a portion of the connecting element is fixed on the body, and another portion of the connecting element extends from the body to be inserted into a connecting hole which is correspondingly provided on the seat and is complementary in shape, so that the support plate is slidably connected to seat part.

13. The child safety seat according to claim 1, wherein the support plate is provided with a first sliding element slidingly fit to a second sliding element correspondingly provided on the seat part, so that the support plate is slidably connected to the seat part;
one of the first sliding element and the second sliding element is a sliding rib, and the other one of the first sliding element and the second sliding element is a sliding slot.

14. The child safety seat according to claim 1, wherein the support plate adjustment mechanism comprises:
an operating element slidably provided on the support plate, capable of sliding between a locking position and a releasing position, and at least partially exposed from the support plate;
a positioning structure provided on the support plate and linked with the operating element to position the support plate in at least one position of the seat part,
wherein when the operating element is in the locking position, the positioning structure is locked so that the support plate is positioned with respect to the seat part; and when the operating element is operated to the releasing position, the positioning structure is unlocked, so that the support plate is movable with respect to the seat part.

15-17. (canceled)

18. The child safety seat according to claim 1, wherein the support plate adjustment mechanism comprises:
a first locking element provided on a body of the support plate and being movable between a locking position and an unlocking position, wherein when the first locking element is in the locking position, the first locking element is engaged with a second locking element on the seat part to position the support plate with respect to the seat part, and when the first locking element is in the unlocking position, the first locking element is disengaged from the second locking element on the seat part so that the support plate is slidable with respect to the seat part.

19. The child safety seat according to claim 18, wherein the first locking element is provided on a lower surface of the body, and when the first locking element is in the locking position, an engaging end of the first locking element passes through a through hole on the body and protrudes from an upper surface of the body.

20. The child safety seat according to claim 19, wherein the first locking element is a strip pivotally connected to the lower surface of the body, the strip is pivotable so that the engaging end protrudes from the upper surface of the body as it is in the locking position, and the engaging end retracts into the body as it is in the unlocking position.

21-24. (canceled)

25. A support plate for a child safety seat, wherein the support plate is slidably connected to a seat part of the child safety seat, and sliding and being positioned between an extended position and a retracted position, the support plate comprises:
a body;
a first sliding element provided on the body and configured to slidingly fit to a second sliding element of the seat part; and
a first locking element provided on the body, and capable of moving between a locking position and an unlocking position, wherein the first locking element engages with a second locking element on the seat part when the first locking element is in the locking position, so that the support plate is positioned with respect to the seat part, and the first locking element disengages from the second locking element on the seat part when the first locking element is in the unlocking position, so that the support plate is capable of sliding with respect to the seat part.

26. The support plate according to claim 25, wherein the support plate further comprises a connecting element fixedly connected to the body, and a connecting hole into which the connecting element is inserted is formed on the seat part.

27. The support plate according to claim 25, wherein the body is formed by connecting an upper cover, a lower cover and a bottom plate, the upper cover and the lower cover form a part of the support plate exposed to the seat part, and the bottom plate is connected to a rear end of the upper cover and a rear end of the lower cover and located between the upper cover and the lower cover.

28. The support plate according to claim 27, wherein the bottom plate has an extension provided with a receiving slot for fixing the connecting member of the seat angle adjustment mechanism.

29. The support plate according to claim 28, wherein the support plate further comprises a connecting element, at least a portion of the connecting element is fixed on the body, another portion of the connecting element extends from the body, and a length of the extension is less than a length of the connecting element extending from the body.

30-38. (canceled)

39. A child safety seat, comprising:
a seat part;
a support plate provided on the seat part;
a base for seating the seat part; and
a seat angle adjustment mechanism provided between the seat part and the base of a child safety seat for adjusting an angle of the seat part with respect to the base, wherein the seat angle adjustment mechanism comprises:
an unlocking operating member provided on the support plate and capable of being operated to move between an unlocking position and a locking position;
an angle locking structure provided between the seat part and the base to lock or unlock the seat part with respect to the base, wherein the angle locking structure has a plurality of locking positions with respect to the base to lock the seat part at a plurality of angles with respect to the base; and
a connecting member connected between the unlocking operating member and the angle locking structure,
wherein when the unlocking operating member is in the locking position, the seat part is positioned with respect to the base; and when the unlocking operating member is operated to the unlocking position, the seat part is slidable with respect to the base,
the support plate comprises a body, the body is formed by connecting an upper cover, a lower cover and a bottom plate, the upper cover and the lower cover form a part of the support plate exposed to the seat part, and the bottom plate is connected to a rear end of the upper cover and a rear end of the lower cover and located between the upper cover and the lower cover; the bottom plate has an extension provided with a receiving slot for fixing the connecting member of the seat angle adjustment mechanism.
